(19) United States
(12) Patent Application Publication
(10) Pub. No.: US 2026/0108919 A1
(43) Pub. Date: Apr. 23, 2026

(54) BATTERY CELL SEPARATION SYSTEM

(71) Applicants: Hyundai Motor Company, Seoul (KR); Kia Corporation, Seoul (KR)

(72) Inventors: Eun Ho Kim, Hwaseong (KR); Jong Min Park, Hwaseong (KR); Yun Su Jeong, Hwaseong (KR); Woo Hyun An, Hwaseong (KR); Won Woo Shin, Hwaseong (KR)

(21) Appl. No.: 19/357,884

(22) Filed: Oct. 14, 2025

(30) Foreign Application Priority Data
Oct. 18, 2024 (KR) 10-2024-0143399
Sep. 18, 2025 (KR) 10-2025-0134594

(51) Int. Cl. B07C 5/34; B07C 5/36; H01M 10/44; H01M 10/48

(52) U.S. Cl. CPC B07C 5/34; B07C 5/362; H01M 10/44; H01M 10/488

(57) ABSTRACT

Disclosed is a battery cell separation system configured to separate and discharge defective battery cells on a cell-by-cell basis during the production process of a battery module assembly (BMA), minimizing a decrease in operating rate in a battery production line.

### CROSS-REFERENCE TO RELATED APPLICATION

This application claims, under 35 U.S.C. § 119(a), the benefit of Korean Patent Application No. 10-2024-0143399, filed Oct. 18, 2024, and Korean Patent Application No. 10-2025-0134594, filed Sep. 18, 2025, the entire contents of which are incorporated herein by reference.

### BACKGROUND

### (a) Technical Field

The present disclosure relates battery cell separation systems and, in particular, to battery cell separation systems configured to separate and discharge battery cells having quality defects in the manufacturing and production process of a battery module assembly.

### (b) Background

Generally, a battery module assembly (BMA) includes a plurality of battery cells stacked on one another, pads stacked between the plurality of battery cells, and end plates brought into close contact with the outer surface of the outermost stacked battery cells.

During the manufacturing and production process of a BMA, a predetermined number of battery cells constitute the BMA. Generally, to improve productivity, a determined number (e.g., six or eight) of battery cells make up one group and are transferred in groups.

For example, twelve battery cells may be required for each BMA, and to produce twelve cells required to make up one BMA, the cells may be transferred in two rows, with each row forming a group of six cells.

Moreover, during the production process of the BMA, various quality inspections may be conducted on the battery cells. The quality inspections distinguish and identify battery cells with defects in insulation, voltage, cell performance, or appearance.

Furthermore, during a cell loading process, where battery cells are transferred via a pitch conveyor and then loaded onto a skid placed on a chain conveyor, any battery cells found to exhibit quality defects, such as cell performance or appearance defects, may be separated and discharged outside. Here, the skid is a type of tray in which the battery cells that make up the BMA are loaded.

However, because, generally, battery cells are transferred in groups, one group of battery cells may be transferred as is from the pitch conveyor to the chain conveyor when no quality defects occur, but, when a specific cell develops a quality defect, all cells in the group to which the specific cell (an issue cell) belongs may be discharged onto a separate pitch conveyor.

Thereafter, only the defective battery cell is moved from the separate pitch conveyor to a discharge bin, and one group of good cells is formed and brought into the chain conveyor to load the group of good cells into a skid.

In some examples, even when a single battery cell develops a quality defect, the entire group (made up of, e.g., six or eight battery cells) must be separated and discharged outside the process, which significantly reduces the operating rate of the battery production line.

Moreover, in some examples, there is no separate cell buffer zone and, thus, the battery production line must be temporarily shut down when defective cells occur consecutively, resulting in a decrease in operating rates.

Furthermore, in some embodiments, even when the number of cells input and transferred changes (e.g., from six to eight) or the number of cells per battery module changes, the unit of cells to be brought in and taken out in a given process cannot vary.

The above information disclosed in this Background section is only for enhancement of understanding of the background of the present disclosure, and therefore it may contain information that does not form the related art that is already known to one having ordinary skill in the art.

### SUMMARY

The present disclosure has been made in an effort to solve the above-described problems associated with the related art, and various aspects of the present disclosure are directed to providing a battery cell separation system capable of separating and discharging defective battery cells on a cell-by-cell basis during the production process of a battery module assembly (BMA), minimizing a decrease in operating rate in a battery production line.

Moreover, various aspects of the present disclosure are directed to providing a battery cell separation system capable of, by including a cell buffer zone, minimizing battery production line downtime and resulting reduced operating rates even when defective cells occur consecutively, and also capable of varying the unit of cells to be brought in and taken out when the unit of input cells or the number of cells per battery module changes.

The aspects of the present disclosure are not limited to the foregoing, and other aspects not mentioned herein will be clearly understood by those of ordinary skill in the art to which the present disclosure pertains (hereinafter, “those skilled in the art”) based on the description below.

To achieve said aspects, the present disclosure provides a battery cell separation system. The battery cell separation system according to an embodiment of the present disclosure may include a transfer conveyor configured to transfer pallets loaded with battery cells to a cell discharge zone, an issue cell identification device configured to identify an issue cell from the battery cells transferred by the transfer conveyor, wherein the issue cell is a battery cell with quality defects, an issue cell conveyor configured to transfer the issue cell and a pallet loaded with the issue cell to an issue cell discharge zone, a cell separator configured to move and separate the issue cell identified by the issue cell identification device, together with the pallet, from the transfer conveyor to the issue cell conveyor, and a cell discharge device configured to pick up the issue cell transferred to the issue cell discharge zone to transfer and discharge out the issue cell.

Moreover, as an embodiment of the present disclosure, the transfer conveyor may have a cell buffer zone provided at a location immediately before the cell discharge zone with respect to a transfer path of the battery cells, wherein good cells, loaded onto pallets, remaining after the issue cell is separated are set to wait in the cell buffer zone until entering the cell discharge zone.

Moreover, as an embodiment of the present disclosure, the transfer conveyor may be a chain conveyor configured to transfer pallets using a chain that is driven and moving, and the battery cell separation system may further include a main stopper device configured to restrict a movement of the pallets based on a main stopper being elevated from below to above the chain by driving of an actuator, and a sub-stopper device mounted behind the main stopper device with respect to a transfer path of the battery cells in the transfer conveyor and configured to restrict the movement of the pallets based on a sub-stopper being elevated from below to above the chain by driving of an actuator.

Moreover, as an embodiment of the present disclosure, the main stopper device may be mounted between the cell buffer zone and the cell discharge zone of the transfer conveyor, and, by the main stopper device and the sub-stopper device, the number of good cells to be transferred from the cell buffer zone to the cell discharge zone may be set or adjusted.

Moreover, as an embodiment of the present disclosure, the issue cell identification device may be a barcode reader unit including a barcode reader configured to read a barcode attached or marked on each battery cell to identify an issue cell from the battery cells.

Moreover, as an embodiment of the present disclosure, the cell discharge device may include a pickup mechanism configured to pick up an issue cell loaded on a pallet at a cell discharge point within the issue cell discharge zone set on the issue cell conveyor, and a three-axis orthogonal unit configured to move the pickup mechanism in orthogonal directions to discharge the issue cell.

Moreover, as an embodiment of the present disclosure,, the transfer conveyor may have an issue cell identification zone in a transfer path of the battery cells, and in the issue cell identification zone, an issue cell is identified by the issue cell identification device from a predetermined number of battery cells, and the cell separator may be configured to selectively move only the identified issue cell, together with a pallet loaded with the issue cell, from the predetermined number of battery cells transferred into the issue cell identification zone to the issue cell conveyor.

Moreover, as an embodiment of the present disclosure, the cell separator may include a plurality of pusher units configured to individually elevate or lower the predetermined number of battery cells transferred into the issue cell identification zone, and to push the identified issue cell while lowered to thereby move the issue cell to the issue cell conveyor, and a linear moving mechanism configured to transfer the plurality of pusher units in a transverse direction across the transfer conveyor and the issue cell conveyor.

Moreover, as an embodiment of the present disclosure, the issue cell conveyor may have an issue cell collection zone, wherein the issue cell moved by the cell separator is set to be placed in the issue cell collection zone, and the battery cell separation system may further include pallet lift devices mounted in the issue cell identification zone of the transfer conveyor and an issue cell collection zone of the issue cell conveyor, respectively, and configured to selectively elevate or lower a pallet located in a corresponding zone, and a controller configured to control an operation of each of the pallet lift devices. Here, the controller may control the operation of each of the pallet lift devices so that the pallet loaded with the issue cell is moved from the issue cell identification zone of the transfer conveyor to the issue cell collection zone of the issue cell conveyor by the cell separator with the pallet being in an elevated state.

Moreover, as an embodiment of the present disclosure, the transfer conveyor may be configured to transfer good cells remaining after an issue cell is separated by the cell separator to the cell discharge zone for external discharge, and the battery cell separation system may further include a retrieval conveyor configured to retrieve empty pallets remaining after good cells are discharged from the cell discharge zone of the transfer conveyor to a cell input zone where battery cells are input.

According to an aspect of the present disclosure, a battery cell separation system is provided. The battery cell separation system may comprise a transfer conveyor configured to transfer one or more pallets loaded with battery cells to a cell discharge zone, an issue cell identification device configured to identify an issue cell from the battery cells transferred by the transfer conveyor, and an issue cell conveyor configured to transfer the issue cell and a pallet loaded with the issue cell to an issue cell discharge zone. The issue cell is a battery cell with one or more quality defects.

According to an exemplary embodiment, the battery cell separation system may comprise a cell separator configured to move and separate the issue cell identified by the issue cell identification device, together with the pallet, from the transfer conveyor to the issue cell conveyor, and a cell discharge device configured to pick up the issue cell transferred to the issue cell discharge zone to transfer and discharge out the issue cell.

According to an exemplary embodiment, the transfer conveyor may have a cell buffer zone provided at a location immediately before the cell discharge zone with respect to a transfer path of the battery cells and may comprise a chain conveyor configured to transfer pallets using a chain that is configured to be driven and moving, and good cells, loaded onto pallets, remaining after the issue cell is separated may be set to wait in the cell buffer zone until entering the cell discharge zone.

According to an exemplary embodiment, the battery cell separation system may comprise a main stopper device configured to restrict a movement of the pallets based on a main stopper being elevated from below to above the chain by driving of an actuator, and a sub-stopper device mounted behind the main stopper device with respect to a transfer path of the battery cells in the transfer conveyor and configured to restrict the movement of the pallets based on a sub-stopper being elevated from below to above the chain by driving of an actuator. The main stopper device may be mounted between the cell buffer zone and the cell discharge zone of the transfer conveyor, and, by the main stopper device and the sub-stopper device, one or more good cells to be transferred from the cell buffer zone to the cell discharge zone may be set or adjusted.

According to an exemplary embodiment, the issue cell identification device may comprise a barcode reader unit comprising a barcode reader configured to read a barcode attached or marked on each battery cell to identify an issue cell from the battery cells.

According to an exemplary embodiment, the cell discharge device may comprise a pickup mechanism configured to pick up an issue cell loaded on a pallet at a cell discharge point within the issue cell discharge zone set on the issue cell conveyor, and a three-axis orthogonal unit configured to move the pickup mechanism in one or more orthogonal directions to discharge the issue cell.

According to an exemplary embodiment, the transfer conveyor may have an issue cell identification zone in a transfer path of the battery cells, the issue cell identification device may be configured to identify, in the issue cell identification zone, an issue cell from a predetermined number of battery cells, and the cell separator may be configured to selectively move only the identified issue cell, together with a pallet loaded with the issue cell, from the predetermined number of battery cells transferred into the issue cell identification zone to the issue cell conveyor.

According to an exemplary embodiment, the cell separator may comprise a plurality of pusher units configured to individually elevate or lower the predetermined number of battery cells transferred into the issue cell identification zone and push the identified issue cell while being lowered to thereby move the issue cell to the issue cell conveyor, and a linear moving mechanism configured to transfer the plurality of pusher units in a transverse direction across the transfer conveyor and the issue cell conveyor.

According to an exemplary embodiment, the battery cell separation system may further comprise a controller configured to control an operation of the cell separator, the pusher units may each comprise a lift actuator configured to be controlled by the controller and a pushing portion configured to move up and down by the lift actuator, and the controller may be configured to control an operation of the lift actuator so that the pushing portion is lowered relative to a pusher unit positioned at the identified issue cell.

According to an exemplary embodiment, the issue cell conveyor may have an issue cell collection zone, the issue cell, moved by the cell separator, may be set to be placed in the issue cell collection zone, the battery cell separation system may further comprise one or more pallet lift devices, mounted in the issue cell identification zone of the transfer conveyor and an issue cell collection zone of the issue cell conveyor, respectively, and configured to selectively elevate or lower a pallet located in a corresponding zone and a controller configured to control an operation of each of the pallet lift devices, and the controller may be configured to control the operation of each of the pallet lift devices so that the pallet loaded with the issue cell is moved from the issue cell identification zone of the transfer conveyor to the issue cell collection zone of the issue cell conveyor by the cell separator with the pallet being in an elevated state.

According to an exemplary embodiment, the transfer conveyor and the issue cell conveyor may each comprise a chain conveyor configured to transfer pallets using a chain that is configured to be driven and moving, and the pallet lift devices may each be configured to, while pallets are being moved from the issue cell identification zone to the issue cell collection zone, elevate the pallets so as to separate the pallets from the chain.

According to an exemplary embodiment, the pallet lift device mounted in the issue cell identification zone of the transfer conveyor may comprise a plurality of pallet lift units configured to individually elevate or lower pallets located within the issue cell identification zone of the transfer conveyor.

According to an exemplary embodiment, the transfer conveyor may be configured to transfer good cells remaining after an issue cell is separated by the cell separator to the cell discharge zone for external discharge, the battery cell separation system may further comprise a retrieval conveyor configured to retrieve empty pallets remaining after good cells are discharged from the cell discharge zone of the transfer conveyor to a cell input zone where battery cells are input, two parallel zones at an infeed side, each defined toward a same end of the transfer conveyor and the retrieval conveyor, and each designated as cell input zones into which a predetermined number of battery cells are input so as to be sorted into issue cells and good cells, and an infeed-side pallet mover configured to move empty pallets or pallets loaded with battery cells from the cell input zone of the retrieval conveyor to the cell input zone of the transfer conveyor, and the predetermined number of battery cells to be sorted may be configured to be put onto empty pallets retrieved to the cell input zone of the retrieval conveyor and onto empty pallets moved from the cell input zone of the retrieval conveyor to the cell input zone of the transfer conveyor by the infeed-side pallet mover.

According to an exemplary embodiment, the battery cell separation system may comprise a controller configured to control an operation of the infeed-side pallet mover. Based on the predetermined number of battery cells being put into the cell input zone of the retrieval conveyor and into the cell input zone of the transfer conveyor and the battery cells in the cell input zone of the transfer conveyor being transferred together with the pallets to the issue cell identification zone where issue cells are identified by the issue cell identification device, the controller may be configured to control the infeed-side pallet mover to move the battery cells and the pallets put into the cell input zone of the retrieval conveyor to the cell input zone of the transfer conveyor.

According to an exemplary embodiment, the battery cell separation system may comprise one or more pallet lift devices mounted in the cell input zone of the transfer conveyor and the cell input zone of the retrieval conveyor, respectively, and configured to selectively elevate or lower a pallet located in a corresponding zone, and a controller configured to control an operation of each of the one or more pallet lift devices. The transfer conveyor and the retrieval conveyor may each comprise a chain conveyor configured to transfer pallets using a chain that is driven and moving, and the controller may be configured to control each of the pallet lift devices to elevate and separate the pallets from the chain while the pallets are being moved from the cell input zone of the retrieval conveyor to the cell input zone of the transfer conveyor by the infeed-side pallet mover.

According to an exemplary embodiment, the transfer conveyor may be configured to transfer good cells remaining after an issue cell is separated by the cell separator to the cell discharge zone for external discharge, and the battery cell separation system may further comprise a retrieval conveyor configured to retrieve empty pallets remaining after good cells are discharged from the cell discharge zone of the transfer conveyor to a cell input zone where battery cells are input, two parallel zones at an outfeed side, each defined toward a same end of the transfer conveyor and the retrieval conveyor, and each designated as cell discharge zones where the good cells remaining after an issue cell is separated are discharged outside, and an outfeed-side pallet mover configured to move empty pallets or pallets loaded with good cells from the cell discharge zone of the transfer conveyor to the cell discharge zone of the retrieval conveyor.

According to an exemplary embodiment, the battery cell separation system may comprise a controller configured to control an operation of the outfeed-side pallet mover. Based on the good cells being discharged outside from the cell discharge zone of the transfer conveyor and from the cell discharge zone of the retrieval conveyor and the empty pallets in the cell discharge zone of the retrieval conveyor being transferred for retrieval, the controller may be configured to control the outfeed-side pallet mover to move the empty pallets in the cell discharge zone of the transfer conveyor to the cell discharge zone of the retrieval conveyor so as to retrieve the empty pallets.

According to an exemplary embodiment, the battery cell separation system may comprise one or more pallet lift devices, mounted in the cell discharge zone of the transfer conveyor and the cell discharge zone of the retrieval conveyor, respectively, and configured to selectively elevate or lower a pallet located in a corresponding zone. The transfer conveyor and the retrieval conveyor may each comprise a chain conveyor configured to transfer pallets using a chain that is driven and moving, and the controller may be configured to control each of the one or more pallet lift devices to elevate and separate the pallets from the chain while the pallets are being moved from the cell input zone of the retrieval conveyor to the cell input zone of the transfer conveyor by the outfeed-side pallet mover.

According to an exemplary embodiment, the transfer conveyor may be configured to transfer good cells remaining after an issue cell is separated by the cell separator to the cell discharge zone for external discharge, the battery cell separation system may further comprise a retrieval conveyor configured to retrieve empty pallets remaining after good cells are discharged from the cell discharge zone of the transfer conveyor to a cell input zone where battery cells are input, the retrieval conveyor may have an empty pallet buffer zone provided at a location immediately before the cell input zone with respect to a transfer path of the empty pallets being retrieved, and the empty pallets may be set to wait in the empty pallet buffer zone until entering the cell input zone.

According to an exemplary embodiment, the transfer conveyor may be configured to transfer good cells remaining after an issue cell is separated by the cell separator to the cell discharge zone for external discharge, the battery cell separation system may further comprise a retrieval conveyor configured to retrieve empty pallets remaining after good cells are discharged from the cell discharge zone of the transfer conveyor to a cell input zone where battery cells are input, an empty pallet mover configured to move empty pallets remaining after issue cells are discharged by the cell discharge device from the issue cell conveyor to the retrieval conveyor, a pallet lift device, mounted at a pallet discharge point on the issue cell conveyor where empty pallets are discharged and at a pallet entry point on the retrieval conveyor where empty pallets enter from issue cell conveyor, and configured to selectively elevate pallets, and a controller configured to control operations of the empty pallet mover and the pallet lift device, the issue cell conveyor and the retrieval conveyor may each comprise a chain conveyor configured to transfer pallets using a chain that is driven and moving, and the controller may be configured to control the operation of the pallet lift device to elevate and separate the empty pallets from the chain while the empty pallets are being moved from the issue cell conveyor to the retrieval conveyor.

According to an aspect of the present disclosure, a battery cell separation system is provided. The battery cell separation system may comprise a computing device comprising a processor and a memory. The memory may be configured to store instructions that, when executed by the processor, are configured to cause the processor to cause a transfer conveyor to transfer one or more pallets loaded with battery cells to a cell discharge zone, identify an issue cell from the battery cells transferred by the transfer conveyor, and cause an issue cell conveyor to transfer the issue cell and a pallet loaded with the issue cell to an issue cell discharge zone. The issue cell is a battery cell with one or more quality defects.

According to an exemplary embodiment, the computing device may be further configured to cause a cell separator to move and separate the issue cell identified by the issue cell identification device, together with the pallet, from the transfer conveyor to the issue cell conveyor, and cause a cell discharge device to pick up the issue cell transferred to the issue cell discharge zone to transfer and discharge out the issue cell.

Other aspects of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a perspective view illustrating a battery cell separation system, according to an exemplary embodiment of the present disclosure.

FIG. 2 illustrates a view showing major zones set on each conveyor in a battery cell separation system, according to an exemplary embodiment of the present disclosure.

FIG. 3 illustrates a block diagram showing major components of a battery cell separation system, according to an exemplary embodiment of the present disclosure.

FIGS. 4A to 4M are views illustrating the operating state of a battery cell separation system, according to an exemplary embodiment of the present disclosure, step-by-step.

FIG. 5 is a perspective view illustrating a pallet lift, according to an exemplary embodiment of the present disclosure.

FIG. 6 is a perspective view illustrating an individual pallet lift unit for separating pallets, according to an exemplary embodiment of the present disclosure.

FIG. 7 is a perspective view illustrating a first pallet mover mounted, according to an exemplary embodiment of the present disclosure.

FIG. 8 is a view illustrating a state in which a lowered pusher is being moved in a left-right transverse direction by a cylinder mechanism of a first pallet mover, according to an exemplary embodiment of the present disclosure.

FIG. 9 is a perspective view illustrating the configuration of devices mounted in a barcode reading zone in a battery cell separation system, according to an exemplary embodiment of the present disclosure.

FIG. 10 is a perspective view illustrating a state in which issue cells are being separated from a barcode reading zone to an issue cell collection zone in a battery cell separation system, according to an exemplary embodiment of the present disclosure.

FIG. 11 is a perspective view illustrating a barcode reader lift, according to an exemplary embodiment of the present disclosure.

FIG. 12 is a perspective view illustrating a state in which a barcode attached to an upper surface of a cell is being read by a barcode reader, according to an exemplary embodiment of the present disclosure.

FIG. 13 is a perspective view illustrating a pusher unit, according to an exemplary embodiment of the present disclosure.

FIG. 14 is a view illustrating a state in which an empty pallet at a pallet discharge point is being moved to a pallet entry point by a third pallet mover, according to an exemplary embodiment of the present disclosure.

FIGS. 15 and 16 illustrate a state in which an issue cell is being moved and discharged to a cell storage bin by a cell discharge device, according to an exemplary embodiment of the present disclosure.

FIG. 17 is a view illustrating chains used in a transfer conveyor, a retrieval conveyor, and an issue cell conveyor, according to an exemplary embodiment of the present disclosure.

FIG. 18 is a view illustrating the operating states of a main stopper device and a sub-stopper device, according to an exemplary embodiment of the present disclosure.

FIG. 19 is a perspective view illustrating a sub-stopper device, according to an exemplary embodiment of the present disclosure.

FIG. 20 is a cross-sectional view illustrating a linear magnetic moving system (LMS) conveyor, according to an exemplary embodiment of the present disclosure.

FIG. 21 illustrates example elements of a computing device, according to an exemplary embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Hereinafter, various embodiments of the present disclosure will be described in detail with reference to the drawings. Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of the present disclosure.

It will be understood that, when a component is referred to as being “connected to” or “coupled to” another component, the component may be directly connected to or coupled to the other component, or intervening components may also be present. In contrast, when a component is referred to as being “directly connected to” or “directly brought into contact with” another component, there is no intervening component present. Other terms used to describe relationships between components such as “between” versus “directly between” and “adjacent” versus “directly adjacent”should be interpreted in a like fashion.

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the other part are indirectly electrically connected to each other.

In addition, the term “unit,” “control unit,” “control device,” or “controller” is merely a widely used term for naming an element or component that controls a specific function, and does not mean a generic functional unit. For example, each controller may include a communication device that communicates with another controller or a sensor to control a function assigned thereto, a computer-readable recording medium that stores an operating system (OS), logic commands, input/output information, and the like, and at least one processor that performs determination, calculation, computation, decision, and the like that are necessary for controlling a function assigned thereto.

Meanwhile, the processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, the computer-readable recording medium (or simply a “memory”) may include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

Hereinafter, various embodiments of the present disclosure will be described in detail with reference to the accompanying drawings.

The present disclosure relates to a battery cell separation system configured to separate and discharge defective battery cells during a battery production process for producing a battery module assembly (BMA) mounted in an electric vehicle.

Particularly, the present disclosure relates to a battery cell separation system configured to separate and discharge defective battery cells on a cell-by-cell basis, regardless of the type of conveyor, such as a chain conveyor or LMS conveyor; the type of battery cell, such as pouch-shaped, square, or cylindrical; or the quantity of battery cells brought in or taken out, during the production process of the BMA, minimizing a decrease in operating rate in a battery production line.

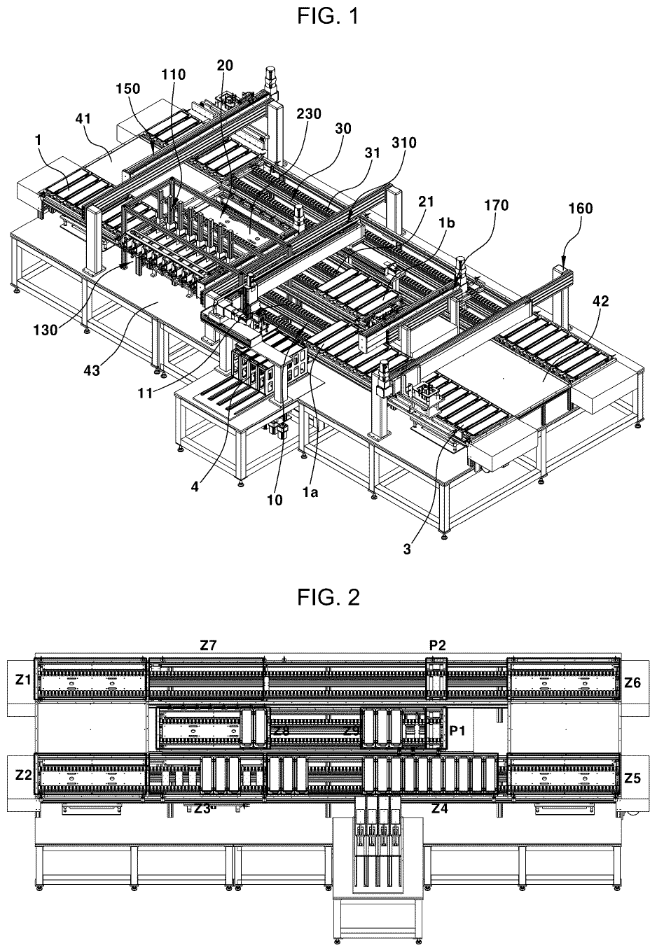

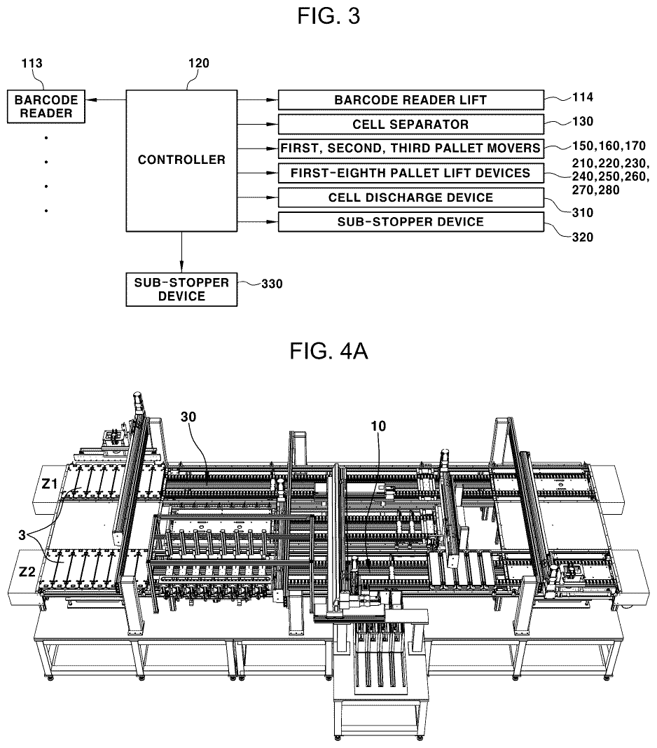

FIG. 1 is a perspective view illustrating a battery cell separation system, according to an exemplary embodiment of the present disclosure, and FIG. 2 illustrates a view showing major zones set on each conveyor in a battery cell separation system, according to an exemplary embodiment of the present disclosure.

In the following description, a battery cell with a quality defect (a defective cell) will be simply referred to as an “issue cell,” and a good quality, defect-free battery cell will be referred to as a “good cell.”

In FIG. 2, reference numeral “Z1” denotes a cell input zone set on an infeed side of a retrieval conveyor 30, reference numeral “Z2” denotes a cell input zone set on an infeed side of a transfer conveyor 10, and reference numeral “Z3” denotes a barcode reading zone set on one side of the transfer conveyor 10.

In FIG. 2, reference numeral “Z4” denotes a cell buffer zone set on another side of the transfer conveyor 10, reference numeral “Z5” denotes a cell discharge zone set on an outfeed side of the transfer conveyor 10, and reference numeral “Z6” denotes a cell discharge zone set on an outfeed side of the retrieval conveyor 30.

In FIG. 2, reference numeral “Z7” denotes an empty pallet buffer zone set on one side of the retrieval conveyor 30, reference numeral “Z8” denotes an issue cell collection zone set on one side (infeed side) of an issue cell conveyor 20, and reference numeral “Z9” denotes an issue cell discharge zone set on another side (outfeed side) of the issue cell conveyor 20.

In FIG. 2, reference numeral “P1” denotes a pallet discharge point P1 where empty pallets 3 are discharged after issue cells 1b are removed from the issue cell conveyor 20, and reference numeral “P2” denotes a pallet entry point P2 on the retrieval conveyor 30 where an empty pallets 3 enter from the issue cell conveyor 20.

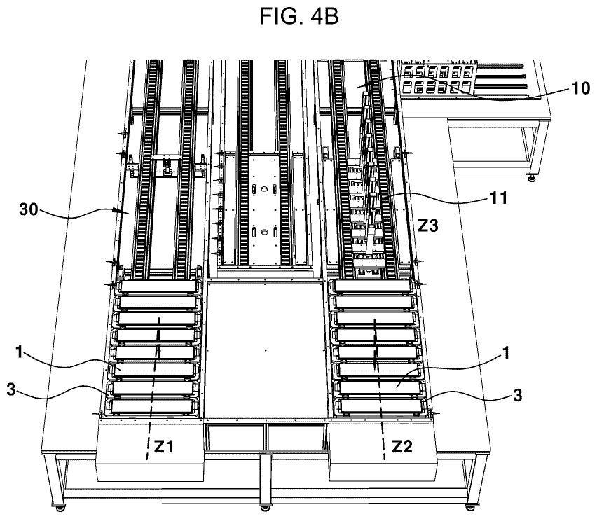

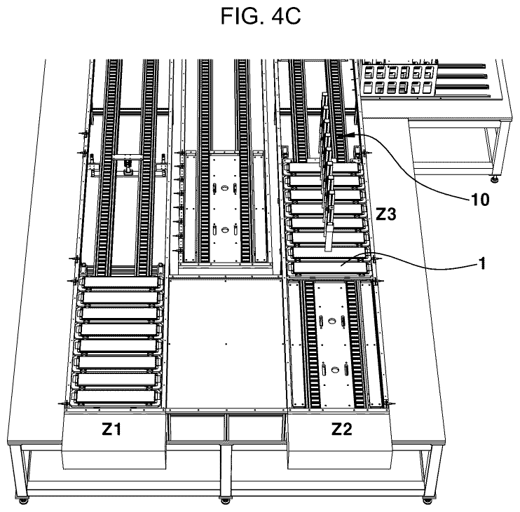

FIG. 3 illustrates a block diagram showing major components of the battery cell separation system, according to an exemplary embodiment of the present disclosure. The battery cell separation system may comprise input elements, control elements, and operation elements. Furthermore, FIGS. 4A to 4M are views illustrating the operating state of the battery cell separation system, according to an exemplary embodiment of the present disclosure, step-by-step.

Below, the configuration of the battery cell separation system and the operating state thereof are described. The control entity for the operation elements constituting the battery cell separation system may comprise a controller 120.

In the following description, reference will be made to FIG. 2 for the reference numerals for the cell input zones Z1, Z2, barcode reading zone Z3, cell buffer zone Z4, cell discharge zones Z5, Z6, empty pallet buffer zone Z7, issue cell collection zone Z8, and issue cell discharge zone Z9. Reference will also be made to FIG. 2 for the reference numerals for the pallet discharge point P1 and the pallet entry point P2.

FIG. 4A is a view illustrating a state immediately before battery cells are put into the battery cell separation system, according to an exemplary embodiment of the present disclosure. Here, empty pallets 3 may be placed in the cell input zone Z1 of the retrieval conveyor 30 and in the cell input zone Z2 of the transfer conveyor 10.

Moreover, FIG. 4B illustrates a state in which battery cells 1 are loaded in groups in the cell input zone Z1 of the retrieval conveyor 30 and in the cell input zone Z2 of the transfer conveyor 10, according to an exemplary embodiment of the present disclosure.

As illustrated in the drawings, a group of battery cells 1 may be loaded onto respective pallets 3 in the cell input zone Z1 of the retrieval conveyor 30, and a group of battery cells 1 may also be loaded onto respective pallets 3 in the cell input zone Z2 of the transfer conveyor 10.

When inputting battery cells 1, individual cell bring-in loaders (not shown) may be used for the retrieval conveyor 30 and the transfer conveyor 10, respectively, and battery cells 1 may be loaded in groups into the cell input zone Z1 of the retrieval conveyor 30 and the cell input zone Z2 of the transfer conveyor 10 by the individual cell bring-in loaders.

As an example, a total of sixteen battery cells 1 may be loaded onto the empty pallets 3 in the cell input zone Z1 and the cell input zone Z2 at the same time by the cell bring-in loaders. By the individual cell bring-in loaders, eight battery cells 1 may be loaded onto the pallets 3 in the cell input zone Z1 of the retrieval conveyor 30, and another eight battery cells 1 may be loaded onto the pallets 3 in the cell input zone Z2 of the transfer conveyor 10. It is noted, however, that other numbers of battery cells 1 may be incorporated, while maintaining the spirit and functionality of the present disclosure.

After each group of battery cells 1 are loaded onto the cell input zone Z1 of the retrieval conveyor 30 and the cell input zone Z2 of the transfer conveyor 10, the battery cells 1 loaded onto the cell input zone Z2 of the transfer conveyor 10 may be first transferred to the barcode reading zone Z3 by a chain 11 of the transfer conveyor 10.

FIG. 4C illustrates a state in which the group of battery cells 1 loaded onto the cell input zone Z2 of the transfer conveyor 10 are transferred to the barcode reading zone Z3 by the transfer conveyor 10, according to an exemplary embodiment of the present disclosure.

FIG. 4D illustrates a state in which issue cells 1b, determined to be defective battery cells 1 in the barcode reading zone Z3, are being moved, together with the pallets 3, in a transverse direction by a cell separator 130 to the issue cell collection zone Z8 of the issue cell conveyor 20 to be separated from good cells 1a, according to an exemplary embodiment of the present disclosure.

According to an exemplary embodiment of the present disclosure, the barcode reading zone Z3 may comprise a region along the transfer path of the battery cells in the transfer conveyor 10. The barcode reading zone Z3 may comprise a transferred cell identification zone where issue cells (defective cells) 1b are identified and determined by a barcode reader 113 and also a cell separation zone where the transferred cells 1b are separated from the good cells 1a.

Moreover, FIG. 4D illustrates a state in which the battery cells 1 having been placed in the cell input zone Z1 of the retrieval conveyor 30 are being moved, together with the respective pallets 3, by a first pallet mover 150 toward the cell input zone Z2 of the transfer conveyor 10 by crossing over an intermediate support 41.

FIG. 4E illustrates a state in which the issue cells 1b having been placed in the issue cell collection zone Z8 are transferred toward the issue cell discharge zone Z9 by a chain 21 of the issue cell conveyor 20, and a state in which the good cells 1a having been placed in the barcode reading zone Z3 are transferred to the cell buffer zone Z4 by the chain 11 of the transfer conveyor 10, according to an exemplary embodiment of the present disclosure.

Moreover, FIG. 4E illustrates a state in which the other group of battery cells 1 having been loaded in the cell input zone Z1 of the retrieval conveyor 30 are waiting before departure after being moved in a transverse direction to the cell input zone Z2 of the transfer conveyor 10.

FIG. 4F illustrates a state in which, after the issue cells 1b have been separated, the good cells 1a are waiting in the cell buffer zone Z4 of the transfer conveyor 10, and a state in which the other group of battery cells 1 are being transferred from the cell input zone Z2 of the transfer conveyor 10 to the barcode reading zone Z3 by the chain 11 of the transfer conveyor 10, according to an exemplary embodiment of the present disclosure. In FIG. 4F, the movement path of a group of good cells 1a when issue cells do not occur is indicated by arrows.

FIG. 4G illustrates a state in which, from the other group of battery cells, only good cells 1a are transferred from the barcode reading zone Z3 to the cell buffer zone Z4 of the transfer conveyor 10 after issue cells 1b have been separated through repeated operations, according to an exemplary embodiment of the present disclosure.

Moreover, FIG. 4G illustrates a state in which some issue cells 1b are collected in the issue cell collection zone Z8 of the issue cell conveyor 20, and another some issue cells 1b are waiting in the issue cell discharge zone Z9.

FIG. 4H illustrates a state in which the issue cells 1b having been placed in the issue cell collection zone Z8 are transferred to the issue cell discharge zone Z9 by the chain 21 of the issue cell conveyor 20, and then two groups of good cells 1a are put together and waiting in the cell buffer zone Z4 of the transfer conveyor 10 through repeated operations, according to an exemplary embodiment of the present disclosure.

FIG. 4I illustrates a state in which one group of good cells 1a are first transferred from the cell buffer zone Z4 to the cell discharge zone Z5 of the transfer conveyor 10, according to an exemplary embodiment of the present disclosure. FIG. 4J illustrates a state in which the preceding one group of good cells 1a are moved in a transverse direction from the cell discharge zone Z5 of the transfer conveyor 10 to the cell discharge zone Z6 of the retrieval conveyor 30, according to an exemplary embodiment of the present disclosure.

Moreover, FIG. 4J illustrates a state in which the remaining subsequent group of good cells 1a are being transferred from the cell buffer zone Z4 of the transfer conveyor 10 toward the cell discharge zone Z5 of the transfer conveyor 10 by the chain 11 of the transfer conveyor 10.

FIG. 4K illustrates a state in which a group of good cells 1a are waiting in each of the cell discharge zone Z5 of the transfer conveyor 10 and the cell discharge zone Z6 of the retrieval conveyor 30 until being discharged, according to an exemplary embodiment of the present disclosure. In this state, the good cells 1a loaded in the cell discharge zones Z5, Z6 of the conveyors 10, 30 are discharged in groups.

To discharge good cells 1a, individual cell take-out loaders (not shown) may be used for the retrieval conveyor 30 and the transfer conveyor 10, respectively. The good cells 1a may be discharged simultaneously from the cell discharge zone Z5 of the transfer conveyor 10 and from the cell discharge zone Z6 of the retrieval conveyor 30 by the individual cell take-out loaders.

As an example, a total of sixteen good cells 1a may be simultaneously taken out from the cell discharge zones Z5, Z6 by the cell take-out loaders. By the individual cell take-out loaders, eight good cells 1a may be taken out from the pallets 3 in the cell discharge zone Z5 of the transfer conveyor 10 and, at the same time, another eight good cells 1a may be taken out from the pallets 3 in the cell discharge zone Z6 of the retrieval conveyor 30.

FIG. 4L illustrates a state in which issue cells 1b are being discharged at a predetermined cell discharge point within the issue cell discharge zone Z9 of the issue cell conveyor 20 to a cell storage bin 4 by a cell discharge device 310, and empty pallets 3 are being retrieved by the retrieval conveyor 30, according to an exemplary embodiment of the present disclosure.

Here, the empty pallets 3 being retrieved may be transferred from the cell discharge zone Z6 of the retrieval conveyor 30 to the cell input zone (reference numeral “Z1” in FIG. 2) by crossing over the empty pallet buffer zone (reference numeral “Z7” in FIG. 2) by a chain 31 of the retrieval conveyor 30.

Moreover, FIG. 4L illustrates a state in which the empty pallets 3 are being transferred from the cell discharge zone Z5 of the transfer conveyor 10 to the cell discharge zone Z6 of the retrieval conveyor 30 by a second pallet mover 160.

FIG. 4M illustrates a state of the empty pallets 3 moved and retrieved to the cell input zone Z1 of the retrieval conveyor 30 and the cell input zone Z2 of the transfer conveyor 10, which shows, together with FIG. 4A, the state before new battery cells are input, according to an exemplary embodiment of the present disclosure.

Moreover, FIG. 4M illustrates a state in which the empty pallets 3 having been placed at the pallet discharge point P1 of the issue cell conveyor 20 are moved in a transverse direction to the pallet entry point P2 of the retrieval conveyor 30.

Hereinafter, the configuration and operating state of the battery cell separation system, according to an exemplary embodiment of the present disclosure, will be described in more detail with reference to each drawing.

As illustrated in FIG. 1, the battery cell separation system, according to an exemplary embodiment of the present disclosure, may comprise the transfer conveyor 10 configured to transfer pallets 3 loaded with battery cells 1 from the cell input zone Z2 to the cell discharge zone Z5, the issue cell conveyor 20 configured to transfer issue cells 1b and pallets 3 loaded with the issue cells 1b to the predetermined issue cell discharge zone Z9 and the pallet discharge point P1, the cell separator 130 configured to move and separate the issue cells 1b, together with the pallets 3, from the transfer conveyor 10 to the issue cell collection zone Z8 of the issue cell conveyor 20, and the cell discharge device 310 configured to pick up the issue cells 1b transferred to the cell discharge point within the issue cell discharge zone Z9 of the issue cell conveyor 20 to transfer and discharge the issue cells 1b to the cell storage bin 4.

The battery cell separation system, according to an exemplary embodiment of the present disclosure, may further comprise the retrieval conveyor 30 configured to transfer and retrieve empty pallets 3 from the cell discharge zone Z6 to the cell input zone Z1 after good cells 1a are discharged, and pallet movers 150, 160, 170 configured to move empty pallets 3 or pallets 3 loaded with battery cells 1 between the transfer conveyor 10, the issue cell conveyor 20, and the retrieval conveyor 30.

According to an exemplary embodiment of the present disclosure, the pallet mover may comprise the first pallet mover 150 configured to move empty pallets 3 or pallets 3 loaded with battery cells 1 from the cell input zone Z1 of the retrieval conveyor 30 to the cell input zone Z2 of the transfer conveyor 10, the second pallet mover 160 configured to move empty pallets 3 or pallets 3 loaded with battery cells 1 from the cell discharge zone Z5 of the transfer conveyor 10 to the cell discharge zone Z6 of the retrieval conveyor 30, and the third pallet mover 170 configured to move empty pallets 3 from the pallet discharge point P1 of the issue cell conveyor 20 to the pallet entry point P2 of the retrieval conveyor 30.

The battery cell separation system, according to an exemplary embodiment of the present disclosure, may further comprise the controller 120 configured to control the overall operation of the battery cell separation system. The controller 120 may be configured to control the operation of the operation elements constituting the battery cell separation system, as well as the operation elements described below. In other words, the control entity for each of the operation elements may comprise the controller 120.

According to an exemplary embodiment of the present disclosure, the transfer conveyor 10 configured to transfer battery cells 1 loaded onto pallets 3, the issue cell conveyor 20 where issue cells 1b are separated to be transferred and waited, and the retrieval conveyor 30 configured to transfer and retrieve empty pallets 3 back to the cell input zone Z1 may be all arranged parallel to one another. In other words, the three conveyors may be arranged to extend in a parallel direction to have the same transfer direction.

According to an exemplary embodiment of the present disclosure, each conveyor 10, 20, 30 may comprise a chain conveyor, which reduces installation costs and manufacturing costs. Alternatively, each conveyor 10, 20, 30 may comprise, as described below, a high-performance linear magnetic moving system or linear motion system (LMS) conveyor that uses magnetic force to transfer pallets and allows for individual pallet position control.

However, any of the various conveyors known to those skilled in the art, in addition to the chain conveyor or LMS conveyor, may be adopted and applied to the each conveyor, as long as they are configured to transfer pallets loaded with battery cells in a predetermined direction.

According to an exemplary embodiment of the present disclosure, the issue cell conveyor 20 may be disposed parallel to the transfer conveyor 10 and the retrieval conveyor 30 in a space between the transfer conveyor 10 and the retrieval conveyor 30, and the cell storage bin 4 may be arranged at a predetermined position at a side of the transfer conveyor 10.

According to an exemplary embodiment of the present disclosure, the parallel zones at the infeed side, defined toward one end portion in the same direction of the transfer conveyor 10 and the retrieval conveyor 30, may be determined to be the cell input zones Z1, Z2 of the corresponding conveyors, and the parallel zones at the outfeed side, defined toward the other end portion in the same direction of the transfer conveyor 10 and the retrieval conveyor 30, may be determined to be the cell discharge zones Z5, Z6 of the corresponding conveyors.

With a plurality of empty pallets 3 loaded within the corresponding cell input zones Z1, Z2 of the transfer conveyor 10 and the retrieval conveyor 30, a group of battery cells (e.g., six or eight cells) 1 may be simultaneously brought in from outside by the cell bring-in loaders (not shown), and then moved and loaded onto the corresponding empty pallets 3. Each position of the empty pallets 3 onto which battery cells 1 may be loaded within the corresponding cell input zones Z1, Z2 of the transfer conveyor 10, and the retrieval conveyor 30 may be a cell input position.

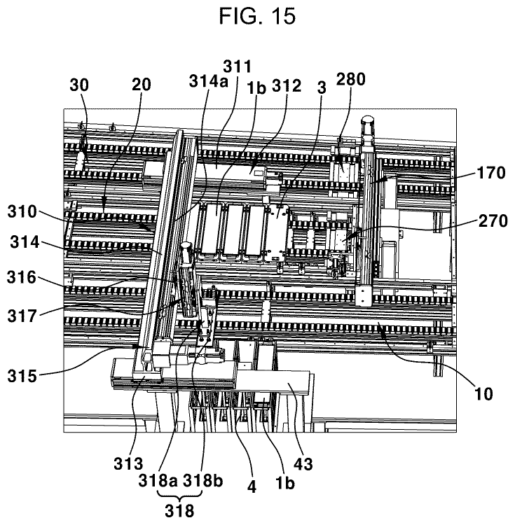

The battery cell separation system, according to an exemplary embodiment of the present disclosure, may further comprise a first pallet lift device (reference numeral “210” in FIG. 17) mounted in the cell input zone Z2 of the transfer conveyor 10 to elevate and support a predetermined number of pallets (e.g., one group of pallets) 3.

Moreover, the battery cell separation system according to an embodiment of the present disclosure may further include a second pallet lift device (reference numeral “220” in FIG. 17) mounted in the barcode reading zone Z3 of the transfer conveyor 10 to elevate and support the pallets 3.

Moreover, the battery cell separation system, according to an exemplary embodiment of the present disclosure, may further comprise a third pallet lift device (reference numeral “230” in FIG. 17) mounted in the issue cell collection zone Z8 of the issue cell conveyor 20 and configured to support the pallets 3 in an elevated state.

Moreover, the battery cell separation system, according to an exemplary embodiment of the present disclosure, may further comprise a fourth pallet lift device (reference numeral “240” in FIG. 17) mounted in the cell discharge zone Z5 of the transfer conveyor 10 and configured to elevate and support a predetermined number of pallets (e.g., one group of pallets) 3.

Moreover, the battery cell separation system, according to an exemplary embodiment of the present disclosure, may further comprise a fifth pallet lift device (reference numeral “250” in FIG. 17) mounted in the cell input zone Z1 of the retrieval conveyor 30 and configured to elevate and support a predetermined number of pallets (e.g., one group of pallets) 3.

Moreover, the battery cell separation system, according to an exemplary embodiment of the present disclosure, may further comprise a sixth pallet lift device (reference numeral “260” in FIG. 17) mounted in the cell discharge zone Z6 of the retrieval conveyor 30 and configured to elevate and support a predetermined number of pallets (e.g., one group of pallets) 3.

Moreover, the battery cell separation system, according to an exemplary embodiment of the present disclosure, may further comprise a seventh pallet lift device (reference numeral “270” in FIG. 17) mounted at the pallet discharge point P1 of the issue cell conveyor 20 and configured to elevate and support empty pallets 3.

Moreover, the battery cell separation system, according to an exemplary embodiment of the present disclosure, may further comprise an eighth pallet lift device (reference numeral “280” in FIG. 17) mounted at the pallet entry point P2 of the retrieval conveyor 30 and configured to support the empty pallets 3 in an elevated state.

According to an exemplary embodiment of the present disclosure, in a state of the pallets 3 elevated by each of the pallet lift devices, the pallets 3 may be separated and spaced apart from the chains 11, 21, 31 of the corresponding conveyors 10, 20, 30. Therefore, even when the chains 11, 21, 31 are driven and moved below the pallets 3, the pallets 3 may keep their position on the pallet lift devices without being moved by the chains 11, 21, 31.

Conversely, in a state of the pallets 3 lowered by each of the pallet lift devices, the pallets 3 may be placed on the chains 11, 21, 31, and, accordingly, when the chains 11, 21, 31 of the corresponding conveyors 10, 20, 30 are driven and moved, the pallets 3 may be transferred along the conveyors by the chains 11, 21, 31.

As such, in the battery cell separation system, according to an exemplary embodiment of the present disclosure, the pallet lift device may comprise the first pallet lift device 210, the second pallet lift device 220, the third pallet lift device 230, the fourth pallet lift device 240, the fifth pallet lift device 250, the sixth pallet lift device 260, the seventh pallet lift device 270, and the eighth pallet lift device 280.

According to an exemplary embodiment of the present disclosure, the pallet lift devices 210-280 may be each mounted in a predetermined zone of each of the conveyors 10, 20, 30, and when moving pallets (empty pallets or pallets loaded with battery cells) 3 between zone to zone, the controller 120 may be configured to control to elevate the pallet lift devices 210-280 in the two zones where the pallets 3 are being moved.

As an example, in moving one group of pallets (empty pallets or pallets loaded with battery cells) 3 placed in the cell input zone Z1 of the retrieval conveyor 30 to the cell input zone Z2 of the transfer conveyor 10, the controller 120 may be configured to elevate both the first pallet lift device 210 on the transfer conveyor 10 side and the fifth pallet lift device 250 on the retrieval conveyor 30 side beforehand, so that the pallets 3 within the corresponding zone may be separated and spaced apart from the chains 11, 31.

Similarly, in moving one group of pallets (empty pallets or pallets loaded with battery cells) 3 placed in the cell discharge zone Z5 of the transfer conveyor 10 to the cell discharge zone Z6 of the retrieval conveyor 30, the controller 120 may be configured to elevate both the fourth pallet lift device 240 on the transfer conveyor 10 side and the sixth pallet lift device 260 on the retrieval conveyor 30 side beforehand, so that the pallets 3 within the corresponding zone may be separated and spaced apart from the chains 11, 31.

Moreover, in moving the empty pallets 3, transferred to the pallet discharge point P1 of the issue cell conveyor 20, to the pallet entry point P2 of the retrieval conveyor 30, the controller 120 may be configured to elevate both the seventh pallet lift device 270 on the issue cell conveyor 20 side and the eighth pallet lift device 280 on the retrieval conveyor 30 side beforehand, so that the pallets 3 at the corresponding point may be separated and spaced apart from the chains 21, 31.

According to an exemplary embodiment of the present disclosure, the first pallet lift device 210, the third pallet lift device 230, the fourth pallet lift device 240, the fifth pallet lift device 250, and the sixth pallet lift device 260 may all be configured as an integrated lift device capable of simultaneously elevating a plurality of (e.g., six or eight) pallets 3 loaded with one group of battery cells 1.

Here, the integrated lift device may comprise a cylinder mechanism described below (not shown), which is a lift actuator, and an integral pallet lift 293 capable of simultaneously elevate or lower one group of pallets 3.

On the other hand, the seventh pallet lift device 270 and the eighth pallet lift device 280 may each be configured to support and elevate or lower only one pallet 3. The seventh pallet lift device 270 and the eighth pallet lift device 280 may also be configured as an integrated pallet lift device having a single cylinder mechanism and an integral pallet lift positioned across the pallet discharge point P1 and the pallet entry point P2.

In moving the empty pallets 3 from the pallet discharge point P1 to the pallet entry point P2, the seventh pallet lift device 270 and the eighth pallet lift device 280 may always operate simultaneously in either ascending or descending motions.

Accordingly, the seventh pallet lift device 270 and the eighth pallet lift device 280 may be configured as an integrated pallet lift device capable of simultaneously elevating or lowering two empty pallets 3 at opposite sides using an integral power lift.

The second pallet lift device 220 mounted in the barcode reading zone Z3 of the transfer conveyor 10 may have the configuration of the integrated lift device described above, similar to other pallet lift devices, but may also have a configuration capable of independently elevating or lowering an individual pallet 3.

In other words, the second pallet lift device 220 may comprise a plurality of individual pallet lift units 221, each capable of independently elevating or lowering a single pallet 3.

The individual pallet lift units 221 may be provided in numbers equal to the quantity of battery cells 1 and pallets 3 constituting one group, and may be configured to be independently controlled by the controller 120 so as to be individually elevated or lowered.

Accordingly, after one group of battery cells 1 and pallets 3 are transferred from the cell input zone Z2 to the barcode reading zone Z3 by the transfer conveyor 10, the controller 120 may be configured to control the operation of a corresponding pallet lift unit 221 to elevate only an issue cell 1b and a pallet 3 loaded with the issue cell 1b from the one group of battery cells 1 in the barcode reading zone Z3, based on the determination made in the barcode reading zone Z3.

Here, the controller 120 may be configured to elevate the third pallet lift device 230 as well, and thus, in a state of only the pallet lift unit 221 loaded with the issue cell 1b elevated, only the issue cell 1b may be selectively moved from the elevated pallet lift unit 221 to the third pallet lift device 230, and when the third pallet lift device 230 is lowered afterwards, the issue cell 1b may be placed on the chain 21 of the issue cell conveyor 20 and transferred to the issue cell discharge zone Z9.

In a case where the second pallet lift device 220 has the configuration of the integrated lift device, the second pallet lift device 220 may be configured to ascend to elevate both issue cell 1b and good cell 1a together, and then selectively move only the issue cell 1b from the second pallet lift device 220 to the third pallet lift device 230.

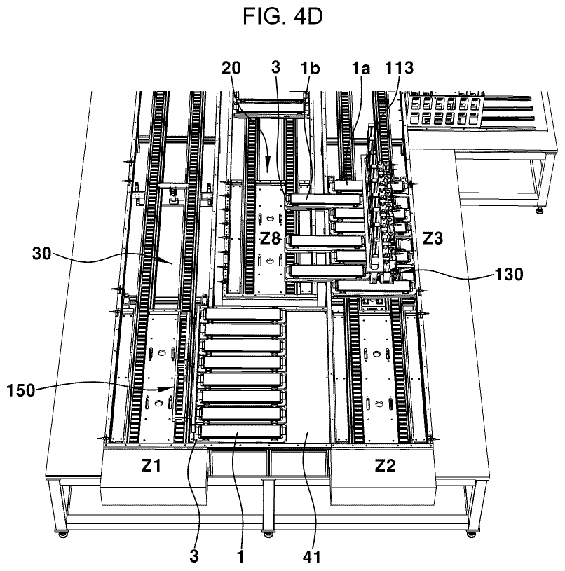

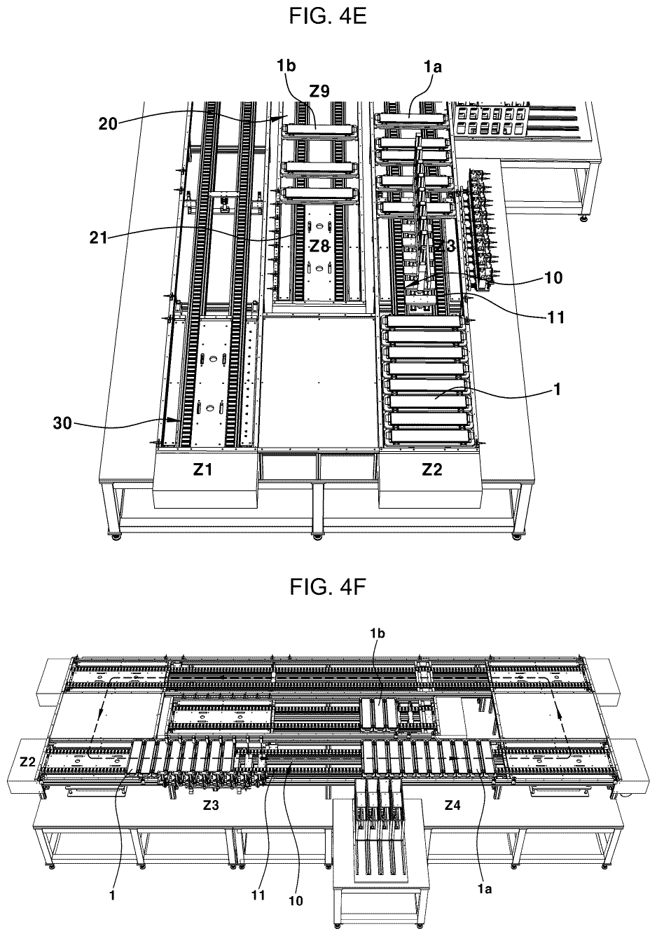

Meanwhile, FIG. 5 is a perspective view illustrating the pallet lift 293, according to an exemplary embodiment of the present disclosure, and FIG. 6 is a perspective view illustrating the individual pallet lift unit 221 for separating pallets, according to an exemplary embodiment of the present disclosure.

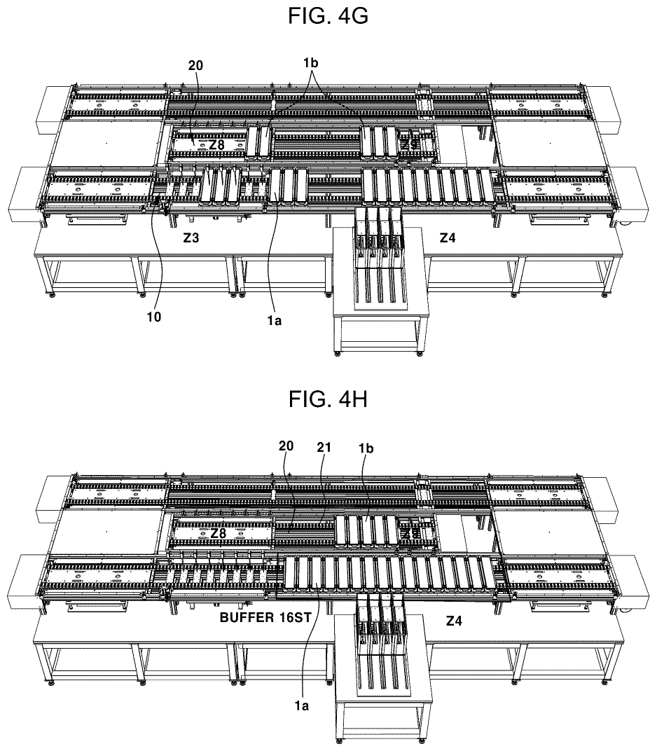

FIG. 7 is a perspective view illustrating the first pallet mover 150 mounted, according to an exemplary embodiment of the present disclosure. Here, the conveyor may comprise a chain conveyor.

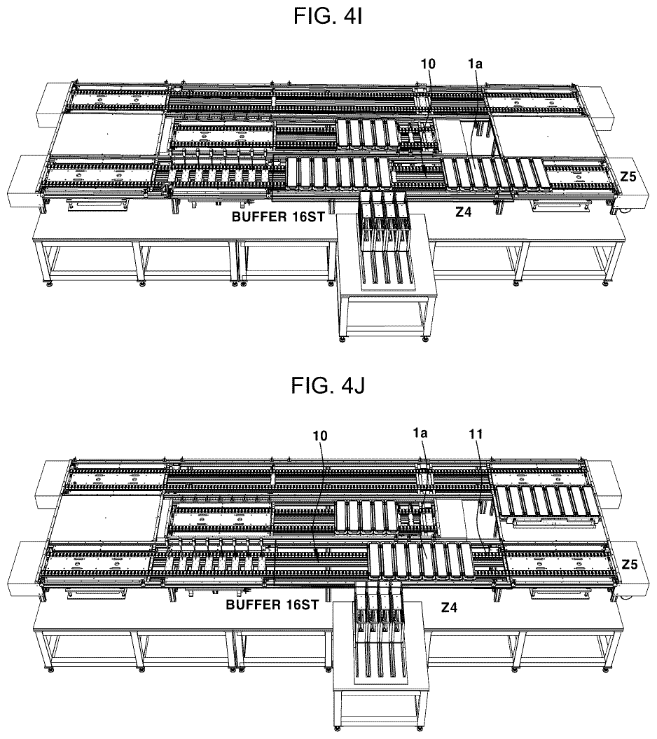

FIG. 8 is a view illustrating a state in which a lowered pusher unit 158 is being moved in a left-right transverse direction by a cylinder mechanism 156 of the first pallet mover 150, according to an exemplary embodiment of the present disclosure.

According to an exemplary embodiment of the present disclosure, the operations of each of the pallet lift devices 210-280 and each of the pallet movers 150, 160, 170 may be controlled by the controller 120. Moreover, the pallet lift devices 210-280 may each be mounted within a corresponding zone of the transfer conveyor 10, the issue cell conveyor 20, and the retrieval conveyor 30.

The first pallet lift device 210, the third to eighth pallet lift devices 230-280, and the individual pallet lift units 221 of the second pallet lift device 220 may be identical in basic configuration, wherein the pallet lifts 225, 293 that move up and down are integrally mounted on a piston rod (a vertical moving member) of a cylinder mechanism (a lift actuator), such as an air cylinder.

The cylinder mechanism (not shown in FIG. 5, but denoted by reference numeral “223” in FIG. 6) of each of the pallet lift devices may comprise a piston rod 224 that is configured to move forward and backward in an up-down vertical direction.

In the above configuration, the operation of a cylinder mechanism 223 may be controlled by the controller 120, allowing the piston rod 224 to move forward and backward. When the cylinder mechanism 223 is controlled by the controller 120 to move the piston rod 224 forward, the pallet lifts 225, 293 may ascend, and when the piston rod 224 moves backward, the pallet lifts 225, 293 may descend. As the piston rod of the cylinder mechanism moves forward and backward in such a way, the pallet lifts of each of the pallet lift devices may be moved up and down.

The configuration of the pallet lift 293 illustrated in FIG. 5 may be applied to the first pallet lift device 210, the third pallet lift device 230, the fourth pallet lift device 240, the fifth pallet lift device 250, and the sixth pallet lift device 260.

The pallet lift 293 may be positioned below the chains 11, 21, 31 within the corresponding zones of the transfer conveyor 10, the issue cell conveyor 20, and the retrieval conveyor 30 when lowered by the cylinder mechanism (not shown).

As illustrated in the drawings, the pallet lift 293 may comprise a frame-structured lift portion 294 configured to ascend and descend as the piston rod of the cylinder mechanism (not shown) moves forward and backward, and a lift plate 295 integrally coupled to an upper portion of the lift portion 294.

Although the cylinder mechanism is not shown in FIG. 5, the cylinder mechanism that moves forward and backward in the up-down direction may be mounted at a lower center of the lift portion 294. An upper end portion of the piston rod of the cylinder mechanism may be coupled to one side of the lift portion 294 or coupled to the lift plate 295 coupled to the lift portion 294.

The lift plate 295 of the pallet lift 293 may comprise a portion on which a pallet 3 is placed and supported. When the pallet lift 293 is elevated by the cylinder mechanism (not shown), which is a lift actuator, the lift plate 295 may be elevated above the chains 11, 21, 31 of the corresponding conveyors 10, 20, 30 and the pallet 3 may be separated and spaced apart from the chains 11, 21, 31.

According to an exemplary embodiment of the present disclosure, the lift plate 295 may comprise a center plate 296 and two side plates 297 spaced apart from the opposite sides of the center plate 296.

The center plate 296 and the side plates 297 may be all coupled to the integral lift portion 294. The chain 11, 21, 31 may be configured to pass through the space between the center plate 296 and the side plates 297.

By allowing the chain 11, 21, 31 to pass through the space between the center plate 296 and the side plates 297, interference between the lift plate 295 and the chain 11, 21, 31 may be prevented while the pallet lift 293 is elevated or lowered.

The pallet lift 293 may be configured to elevate a pallet (an empty pallet, or a pallet loaded with a battery cell) 3 placed on the chain 11, 21, 31 of the transfer conveyor 10, the issue cell conveyor 20, or the retrieval conveyor 30 to separate the pallet from the chain 11, 21, 31.

Here, the lift plate 295 of the pallet lift 293 may be configured to elevate the pallet 3 from the chain 11, 21, 31. In other words, when the pallet lift 293 ascends, the side plates 297 of the lift plate 295 may come into contact with opposite end portions of the pallet 3 located outside the chain 11, 21, 31 (each chain made up of two parallel chains) and lift the opposite end portions of the pallet 3 upward.

Moreover, the center plate 296 of the lift plate 295 may be configured to come into contact with a middle portion of the pallet 3 located inside between the two parallel chains to lift the middle portion of the pallet 3. Here, the center plate 296 and the side plates 297 may be configured to lift the pallet 3 so that the pallet 3 does not tilt to either side.

FIG. 6 illustrates a configuration applicable to the seventh pallet lift device 270, the eighth pallet lift device 280, and the pallet lift units 221 of the second pallet lift device 220 for separating pallets 3, according to an exemplary embodiment of the present disclosure.

Similarly, the cylinder mechanism 223, which is a lift actuator, may comprise the piston rod (a vertical moving member) 224 that is configured to move forward and backward in the up-down vertical direction, wherein an upper end of the piston rod 224 may be coupled to the pallet lift 225.

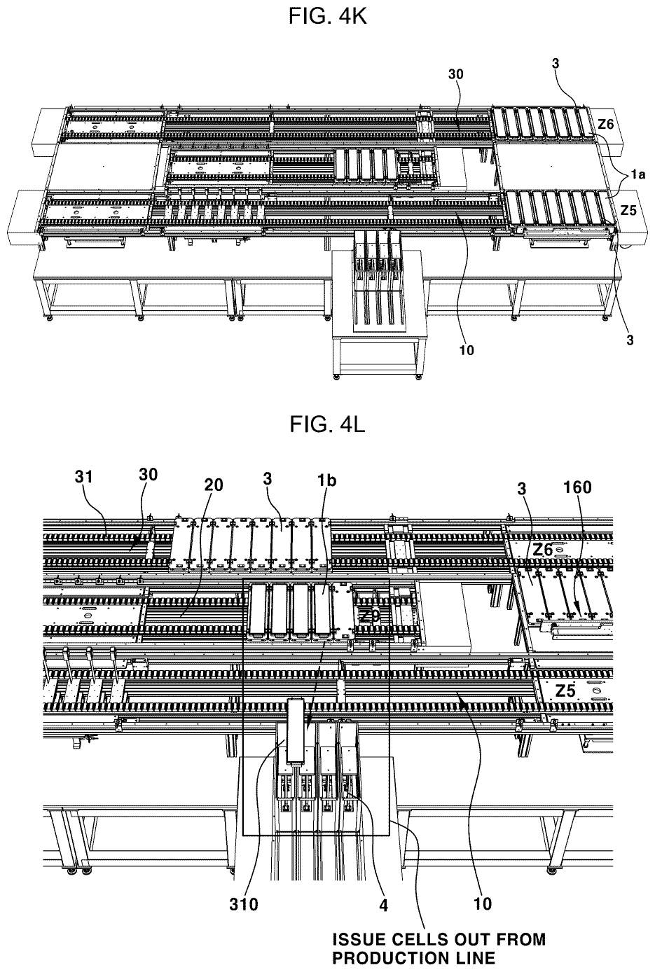

The pallet lift 225 may comprise a lift portion 226 configured to ascend and descend as the piston rod 224 of the cylinder mechanism 223 moves forward and backward, and a lift plate (not shown in FIG. 6, but denoted by reference numeral “227” in FIG. 9) integrally coupled to an upper portion of the lift portion 226.

In FIG. 6, reference numeral “222” denotes a base on which the cylinder mechanism 223 is fixedly mounted, and reference numeral “228” denotes a guide mechanism mounted between the base 222 and the lift portion 226 of the pallet lift 225 to guide the vertical movement of the lift portion 226 so that the lift portion 226 may stably move up and down relative to the base 222, which is a fixed portion.

The guide mechanism 228 may comprise a fixed rod 228a mounted on the base 222, and a movable rod 228b mounted on the lift portion 226 and axially slidably coupled to the fixed rod 228a.

Accordingly, when the pallet lift 225 is in an elevated state, an empty pallet 3 or a pallet 3 loaded with a battery cell 1 placed on the chain 11, 21, 31 of the transfer conveyor 10, the issue cell conveyor 20, and the retrieval conveyor 30 may be supported by the pallet lift 225 at a position where the pallet 3 is elevated and separated from the chain 11, 21, 31. Here, because the pallet 3 is separated from the chain 11, 21, 31, the pallet 3 and battery cell 1 may stay in position even when the chain 11, 21, 31 is driven and moving.

Conversely, when the pallet lift 225 is lowered, the pallet 3 may be placed on the chain 11, 21, 31, and the pallet 3 may be transferred by the chain 11, 21, 31 while the chain 11, 21, 31 is driven and moving.

According to an exemplary embodiment of the present disclosure, battery cells 1 may be loaded onto the empty pallets 3 positioned in the cell input zones Z1, Z2 of the transfer conveyor 10 and the retrieval conveyor 30 by the cell bring-in loaders (not shown). Here, the pallet lifts 293 of the first pallet lift device 210 and the fifth pallet lift device 250 may be in an elevated state.

Thereafter, when the pallet lift 225 of the first pallet lift device 210 descends, one group of battery cells and pallets (six or eight cells and pallets) placed within the cell input zone Z2 of the transfer conveyor 10 may be transferred by the chain 11 to the barcode reading zone Z3 while the chain 11 of the transfer conveyor 10 is driven and moving. Here, the fifth pallet lift device 250 mounted in the cell input zone Z1 of the retrieval conveyor 30 may be configured to keep the pallet lift 293 in an elevated state.

Moreover, once the one group of battery cells 1 and pallets 3 are transferred to the barcode reading zone Z3, the controller 120 may be configured to control the operation of the first pallet lift device 210 to elevate the pallet lift 293 of the first pallet lift device 210 back again.

Thereafter, the one group of battery cells 1 and pallets 3 may be moved in a transverse direction by the first pallet mover 150, which is an infeed-side pallet mover, on the pallet lift 293 of the fifth pallet lift device 250. Here, the one group of battery cells 1 and pallets 3 may be simultaneously moved onto the pallet lift 293 of the first pallet lift device 210 by crossing over the intermediate support 41.

As such, the battery cell separation system, according to an exemplary embodiment of the present disclosure, may further comprise the first pallet mover 150 configured to move one group of battery cells 1 and pallets 3 from the cell input zone Z1 of the retrieval conveyor 30 to the cell input zone Z2 of the transfer conveyor 10.

According to an exemplary embodiment of the present disclosure, the first pallet mover 150, which may comprise an infeed-side pallet mover, as well as the second pallet mover 160, which may comprise an outfeed-side pallet mover described below, are devices configured to move empty pallets 3 or pallets 3 loaded with battery cells 1 from one conveyor to another conveyor.

Moreover, the third pallet mover 170, which is an empty pallet mover described below, may also comprise a device configured to move empty pallets 3 from one conveyor (issue cell conveyor) to another conveyor (retrieval conveyor).

While the pallet movers 150, 160, 170 move the pallets 3 in a transverse direction, the controller 120 may be configured to operate the pallet lift devices 210-280 of two conveyors 10, 20, 30 next to each other by which the pallets 3 are moved in a transverse direction to elevate the pallet lifts 225, 293.

This also applies to the individual pallet lift units 221 of the second pallet lift device 220 for separating pallets mounted in the barcode reading zone, as well as to the seventh pallet lift device 270 and the eighth pallet lift device 280 having the configuration of the individual pallet lift unit 221.

Moreover, after moving of the pallets 3 between the conveyors 10, 20, 30 is completed, the pallet lift devices 210-280 at opposite sides may be controlled by the controller 120 to lower the pallet lifts 225, 295 back again.

As such, when moving the pallets 3 between two conveyors 10, 20, 30 arranged next to each other, the pallets 3 may be moved while the pallet lifts 225, 293 of the pallet lift devices 210-270 on both sides are all elevated, and when the pallet lifts 225, 293 are lowered back again after the pallets 3 are moved, the pallets 3 are placed on the chain 11, 21, 31, allowing the pallets 3 to be transferred by the chain 11, 21, 31.

According to an exemplary embodiment of the present disclosure, the first pallet mover 150 may comprise, as illustrated in FIG. 7, a guide support 151 mounted to extend in a transverse direction across the transfer conveyor 10 and the retrieval conveyor 30, a linear moving mechanism 152 configured to allow a moving block 154 to move along a guide rail 153 mounted on the guide support 151 by extending in the transverse direction, a lift actuator 156 fixed to the moving block 154, and the pusher unit 158 configured to be movable up and down by the lift actuator 156 and to simultaneously pushes to move pallets (empty pallets or pallets loaded with battery cells) 3 in the transverse direction, i.e., the left-right direction.

According to an exemplary embodiment of the present disclosure, the linear moving mechanism 152 may be mounted along the guide support 151. The linear moving mechanism 152 may comprise a general linear motion (LM) system comprising a rail, a block, and a linear actuator 155.

In other words, the linear moving mechanism 152 may have the configuration of the LM system and may comprise the guide rail 153 mounted to the guide support 151 by extending along the guide support 151 in the transverse direction, the moving block 154 coupled to the guide rail 153, and the linear actuator 155 configured to move the moving block 154 along the guide rail 153. The linear actuator 155 may comprise a ball screw actuator or a linear motor.

The configuration of the LM system is well-known to those skilled in the art and, therefore, a detailed description of the configuration of the LM system will be omitted herein.

According to an exemplary embodiment of the present disclosure, the lift actuator 156 may be mounted on the moving block 154 and may be configured to move, together with the moving block 154, along the guide rail 153 mounted on the guide support 151. The lift actuator 156 may comprise a cylinder mechanism having a piston rod 157 configured to move forward and backward in the up-down direction, and may comprise, specifically, an air cylinder or a hydraulic cylinder.

In the first pallet mover 150, the operations of the linear moving mechanism 152 and the lift actuator 156 may be controlled by the controller 120. Specifically, the operation of the linear actuator 155 of the linear moving mechanism 152 and the operation of the cylinder mechanism, which is the lift actuator 156, may be controlled respectively by the controller 120.

According to an exemplary embodiment of the present disclosure, the pusher unit 158 may be configured to be integrally fixed to the piston rod 157 of the cylinder mechanism, which may comprise the lift actuator 156, and may have a shape and structure extending in a direction in which the pallets 3 are arranged, i.e., a length direction of the transfer conveyor 10 and the retrieval conveyor 30, so as to push and move the pallets 3 loaded with one group of battery cells 1 all at once in the transverse direction.

FIG. 8 illustrates a state in which one group of battery cells 1 and pallets 3 in the cell input zone Z1 of the retrieval conveyor 30 are being moved in the transverse direction by the first pallet mover 150 to the cell input zone Z2 of the transfer conveyor 10, according to an exemplary embodiment of the present disclosure.

Referring to FIG. 8, one group of battery cells 1 and pallets 3 may be configured to pass over the intermediate support 41 between two conveyors. Here, the first pallet lift device 210 and the fifth pallet lift device 250, mounted in both zones where the pallets 3 are moved, may be in a state of being operated to elevate the pallet lift 293, as described above.

Accordingly, in moving the pallets 3 loaded with one group of battery cells 1 in the transverse direction from the cell input zone Z1 of the retrieval conveyor 30 to the cell input zone Z2 of the transfer conveyor 10, the piston rod 157 of the cylinder mechanism, which is the lift actuator 156, may move downward, and the pusher unit 158 may be lowered, as illustrated, e.g., in FIG. 8.

Next, the linear moving mechanism 152 may be configured to operate to move the moving block 154 along the guide rail 153. Here, the pusher unit 158 may be configured to push to move one group of battery cells 1 and pallets 3 all at once from the cell input zone Z1 of the retrieval conveyor 30 to the cell input zone Z2 of the transfer conveyor 10.

Afterwards, the piston rod 157 of the cylinder mechanism, which is the lift actuator 156, may move upward, the pusher unit 158 may be elevated back again together with the piston rod 157, and the moving block 154 may move back to the original position along the guide support 151 by the operation of the linear moving mechanism 152. Accordingly, the lift actuator 156 and the pusher unit 158 may be positioned, together with the moving block 154, on the cell input zone Z1 side of the retrieval conveyor 30.

Thereafter, with the pallet lifts 293 of the first pallet lift device 210 and the fifth pallet lift device 250 lowered back again, the battery cells 1 and pallets 3 moved to the cell input zone Z2 of the transfer conveyor 10 may be sequentially transferred along the transfer path same as that of the battery cells 1 and pallets 3 previously transferred to the barcode reading zone Z3 by the chain 11 of the transfer conveyor 10.

Thereafter, the pallet lifts 293 of the first pallet lift device 210 and the fifth pallet lift device 250 may be controlled to be elevated back again. The configuration of devices mounted in the barcode reading zone Z3 will be described below in detail.

Moreover, according to an exemplary embodiment of the present disclosure, a group of battery cells (good cells after issue cells are separated) 1 and pallets 3 loaded with the group of battery cells transferred to the cell discharge zone Z5 by the transfer conveyor 10 may be discharged outside by the cell take-out loader (not shown) from the cell discharge zone Z5 of the transfer conveyor 10, or may be moved in the transverse direction from the cell discharge zone Z5 of the transfer conveyor 10 to the cell discharge zone Z6 of the retrieval conveyor 30 and then discharged outside by the cell take-out loader from the cell discharge zone Z6 of the retrieval conveyor 30.

Furthermore, when a group of good cells 1a is discharged directly from the cell discharge zone Z5 of the transfer conveyor 10 by the cell take-out loader, only a group of empty pallets 3 may remain in the cell discharge zone Z5 of the transfer conveyor 10, and the group of empty pallets 3 must be transferred to the cell discharge zone Z6 of the retrieval conveyor 30 for retrieval.

To this end, the battery cell separation system, according to an exemplary embodiment of the present disclosure, may further comprise the second pallet mover 160 configured to move a group of pallets (pallets loaded with good cells or empty pallets) 3 from the cell discharge zone Z5 of the transfer conveyor 10 to the cell discharge zone Z6 of the retrieval conveyor 30.

The second pallet mover 160 may be different from the first pallet mover 150 described above only in the mounted position and movement direction to move a group of pallets 3 in the transverse direction from the cell discharge zone Z5 of the transfer conveyor 10 to the cell discharge zone Z6 of the retrieval conveyor 30, and the configuration of the second pallet mover 160 may be no different from the first pallet mover 150. Because, according to an embodiment, the configuration of the second pallet mover 160 may be no different from that of the first pallet mover 150, a detailed description of the second pallet mover 160 will be omitted.

Moreover, in the process of moving the pallets 3 from the cell discharge zone Z5 of the transfer conveyor 10 to the cell discharge zone Z6 of the retrieval conveyor 30, the pallets 3 may be allowed to pass through the intermediate support 42 between the two zones, and the pallet lifts 293 of the fourth pallet lift device 240 and the sixth pallet lift device 260 may be elevated and then lowered when the moving of the pallets 3 is completed, which are the same as in the process of moving the pallets 3 from the cell input zone Z1 of the retrieval conveyor 30 to the cell input zone Z2 of the transfer conveyor 10.

According to an exemplary embodiment of the present disclosure, after the preceding group of good cells 1a and pallets 3 are moved in the transverse direction by the second pallet mover 160, another group of good cells 1a and pallets 3 may be subsequently transferred and positioned in the cell discharge zone Z5 of the transfer conveyor 10 from the cell buffer zone Z4 by the operation of the transfer conveyor 10.

With the good cells 1a positioned within the respective cell discharge zones Z5, Z6 of the transfer conveyor 10 and the retrieval conveyor 30 as described above, the good cells 1a within the cell discharge zones Z5, Z6 of the two conveyors 10, 30 may be picked up by the cell take-out loader and then taken out to the outside.

Here, a group of good cells 1a may be simultaneously picked up by the cell take-out loader from the pallets 3 within the cell discharge zones Z5, Z6 of both the transfer conveyor 10 and the retrieval conveyor 30 and taken out to the outside.

The battery cells 1 taken out from the cell discharge zones Z5, Z6 in the cell separation process are the remaining good cells after the issue cells 1b are separated from the barcode reading zone Z3.

Meanwhile, according to an exemplary embodiment of the present disclosure, as illustrated in FIG. 2, the barcode reading zone Z3 and the cell buffer zone Z4 may be set between the cell input zone Z2 and the cell discharge zone Z5 throughout the entire zone of the transfer conveyor 10.

The barcode reading zone Z3 may be positioned adjacent to the cell input zone Z2 and positioned immediately after the cell input zone Z2 with respect to the cell transfer path. Moreover, the cell buffer zone Z4 may be positioned adjacent to the cell discharge zone Z5 and positioned immediately before the cell discharge zone Z5 with respect to the cell transfer path.

The cell buffer zone Z4 may be located between the barcode reading zone Z3 and the cell discharge zone Z5. Accordingly, the zones in the transfer conveyor 10 may be arranged in the following order: the cell input zone Z2, the barcode reading zone Z3, the cell buffer zone Z4, and the cell discharge zone Z5 along the transfer path of the battery cells 1 and pallets 3.

According to an exemplary embodiment of the present disclosure, the empty pallet buffer zone Z7 may be set in the retrieval conveyor 30 as described above, and the empty pallet buffer zone Z7 may be arranged adjacent to the cell input zone Z1.

In other words, the cell input zone Z1 and the cell discharge zone Z6 may be located at opposite end portions of the retrieval conveyor 30, and the empty pallet buffer zone Z7 may be positioned immediately before the cell input zone Z1 with respect to the transfer path of the empty pallets 3.

Accordingly, the empty pallets 3 on the retrieval conveyor 30 may pass through the empty pallet buffer zone Z7 during the process of being retrieved from the cell discharge zone Z6 to the cell input zone Z1, and may temporarily wait until the fifth pallet lift device 250 is lowered in the empty pallet buffer zone Z7 before entering the cell input zone Z1.

In the battery cell separation system, according to an exemplary embodiment of the present disclosure, barcode reading may be performed using a barcode reader (BCR) 113 in the barcode reading zone Z3 of the transfer conveyor 10, and from the battery cells 1 transferred to the barcode reading zone Z3, an issue cell 1b is identified through barcode reading that recognizes a barcode 2 marked or attached to each battery cell 1.

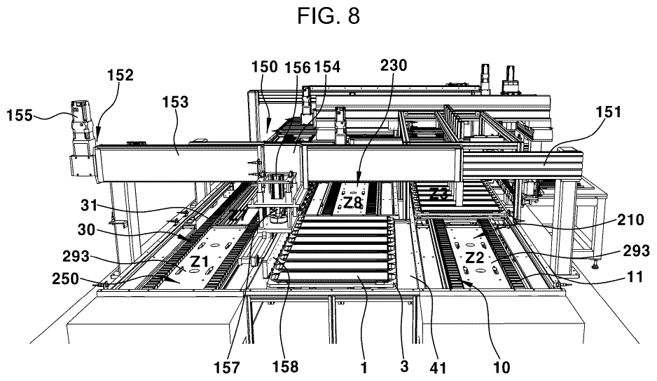

Here, the issue cell 1b is a battery cell that has been determined to have quality defects in a previous inspection process (inspection on insulation, voltage, appearance, etc.). Before being put into the cell separation process, the barcode 2 may be attached to an upper surface of each battery cell 1 to sort out good cells 1a and issue cells 1b (see FIG. 12).

Accordingly, the controller 120 may be configured to distinguish and identify an issue cell 1b from a group of battery cells 1 within the barcode reading zone Z3 based on the barcode ID, which comprises identification information recognized by the barcode reader 113 in the barcode reading zone Z3, and may be configured to separate the identified issue cell 1b into the issue cell collection zone Z8.

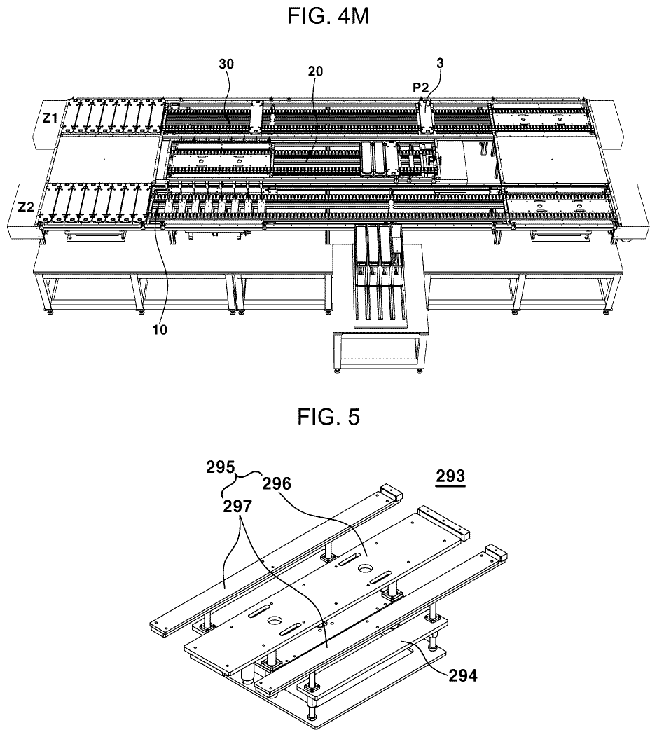

To explain the barcode reading and issue cell separation process during the cell separation process in more detail, FIG. 9 is a perspective view illustrating the configuration of devices mounted in the barcode reading zone Z3 in the battery cell separation system, according to an exemplary embodiment of the present disclosure, and FIG. 10 is a perspective view illustrating a state in which issue cells 1b are being separated from the barcode reading zone Z3 to the issue cell collection zone Z8 in the battery cell separation system, according to an exemplary embodiment of the present disclosure.

FIGS. 9 and 10 illustrate a barcode reader (BCR) unit 110 configured to perform barcode reading, the cell separator 130 configured to move issue cells 1b in the transverse direction to separate the issue cells 1b from good cells 1a, the second pallet lift device 220 configured to selectively and individually elevate a group of pallets 3 in the barcode reading zone Z3, and the third pallet lift device 230 configured to support the pallets 3 in an elevated state and lower the pallets 3 in the issue cell collection zone Z8, according to an exemplary embodiment of the present disclosure.

The BCR unit 110 may comprise an issue cell identification device configured to perform barcode reading to identify and distinguish issue cells 1b from the group of battery cells 1 transferred to the barcode reading zone Z3 along the transfer conveyor 10.

The BCR unit 110 may comprise a plurality of barcode readers 113 that individually read barcodes (reference numeral “2” in FIG. 12) for the group of battery cells 1 placed within the barcode reading zone Z3. The BCR unit 110 may further comprise a barcode reader lift 114 configured to move the plurality of barcode readers 113 up and down.

The battery cells 1 and the barcode readers 113 may be provided in equal numbers so that the barcode readers 113 may each be used for a corresponding one of the battery cells 1 transferred into the barcode reading zone Z3.

In other words, so as to align barcode readers 113 with corresponding battery cells, respectively, the battery cells 1 and the barcode readers 113, provided in equal numbers, may be positioned at equal intervals within the barcode reading zone Z3.

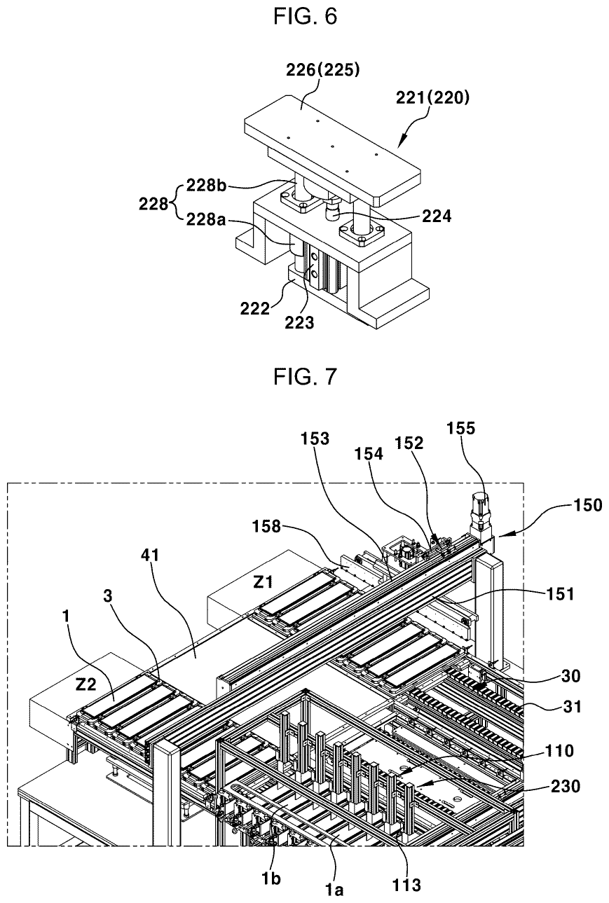

FIG. 11 is a perspective view illustrating the barcode reader lift 114, according to an exemplary embodiment of the present disclosure, and FIG. 12 is a perspective view illustrating a state in which the barcode 2 attached to the upper surface of a battery cell 1 is being read by the barcode reader 113, according to an exemplary embodiment of the present disclosure.

As illustrated in the drawing, the barcode reader lift 114 may comprise a support plate 115 on which a plurality of barcode readers 113 are fixed and supported, and a cylinder mechanism 117 configured to act as a lift actuator that moves the support plate 115 up and down.

According to an exemplary embodiment of the present disclosure, the cylinder mechanism 117 may comprise an air cylinder or hydraulic cylinder having a piston rod (vertical moving member) 118 that is configured to move forward and backward in the up-down direction. Moreover, the cylinder mechanism 117 may be fixedly mounted to a fixed frame 116, and the support plate 115 may be integrally coupled to the piston rod 118 of the cylinder mechanism 117.

Moreover, the support plate 115 may be arranged above the fixed frame 116 mounted to be fixed in position within the barcode reading zone Z3, and may be vertically movably coupled to the fixed frame 116 via a guide mechanism including a guide rod 119.

Each of the barcode readers 113 positioned at regular intervals within the barcode reading zone Z3 may be supported by the support plate 115 via a respective support bracket 112. The respective support bracket 112 may be vertically slidably mounted to a mount frame 111 mounted within the barcode reading zone Z3.

According to an exemplary embodiment of the present disclosure, after a group of battery cells 1 and pallets 3 loaded with the group of battery cells 1 are transferred into the barcode reading zone Z3, the barcode reader lift 114 of the BCR unit 110 may be configured to operate to elevate the barcode readers 113 simultaneously.

Thereafter, as illustrated in FIG. 12, each barcode reader 113 may be configured to read the barcode 2 attached to the upper surface of the corresponding battery cell 1, and then transmit a signal indicating the read barcode ID to the controller 120. Accordingly, the controller 120 may be configured to distinguish and recognize issue cells 1b from good cells 1a within the battery cells 1 in the barcode reading zone Z3 based on the signal received from each barcode reader 113.

Next, the controller 120 may be configured to operate the individual pallet lift units 221 of the second pallet lift device 220 for corresponding issue cells to elevate the pallets 3 loaded with the issue cells 1b via corresponding pallets lift 225, and operate the third pallet lift device 230 mounted in the issue cell collection zone Z8 of the issue cell conveyor 20 to elevate the pallet lifts 293.

Next, the cell separator 130 may be configured to push the issue cells 1b and the pallets 3 loaded with the issue cells 1b elevated by the individual pallet lift units 221 onto the pallet lifts 293 of the third pallet lift device 230 within the issue cell collection zone Z8 of the issue cell conveyor 20 and moves the same in the transverse direction.

Therefore, only the issue cells 1b within the group of battery cells 1 placed in the barcode reading zone Z3 may be selectively moved to the issue cell collection zone Z8 of the issue cell conveyor 20 and separated from the good cells 1a.

According to an exemplary embodiment of the present disclosure, the cell separator 130 may have a similar configuration compared to the first pallet mover 150 and the second pallet mover 160, but may differ in that the cell separator 130 has an individual pusher unit 137 for each battery cell 1 and pallet 3, and that the plurality of individual pusher units 137 may be independently controlled to be moved up and down by the controller 120.

According to an exemplary embodiment of the present disclosure, the cell separator 130 may comprise, as illustrated in FIGS. 9 and 10, a guide support 131 mounted to extend across at least the transfer conveyor 10 and the issue cell conveyor 20 in the transverse direction, a linear moving mechanism 132 configured to move a moving block 134 along a guide rail 133 mounted on the guide support 131 by extending in the transverse direction, and the pusher unit 137 mounted to the moving block 134 via a mounting bracket and configured to push and move pallets 3 loaded with issue cells 1b in the transverse direction, i.e., the left-right direction.

According to an exemplary embodiment of the present disclosure, the linear moving mechanism 132 may be mounted along the guide support 131. The linear moving mechanism 132 may comprise a general linear motion (LM) system including a rail, a block, and a linear actuator.

In other words, the linear moving mechanism 132 may have the configuration of the LM system and may comprise a guide rail 133 mounted to the guide support 131 by extending along the guide support 131 in the transverse direction, a moving block 134 coupled to the guide rail 133, and a linear actuator 135 configured to move the moving block 134 along the guide rail 133. The linear actuator 135 may comprise a ball screw actuator or a linear motor.

The configuration of the LM system is well-known to those skilled in the art, and therefore, a detailed description of the configuration of the LM system will be omitted herein.

The plurality of pusher units 137 may be mounted along a mount support 136 that is mounted in a longitudinally elongated structure on the moving block 134. The plurality of pusher units 137 may be mounted at a predetermined interval on the mount support 136 so that one pusher unit is positioned at each corresponding battery cell and pallet location within the barcode reading zone Z3. The plurality of pusher units 137 may be mounted at the same intervals and in the same number as the battery cells 1 and pallets 3 positioned downward within the barcode reading zone Z3.

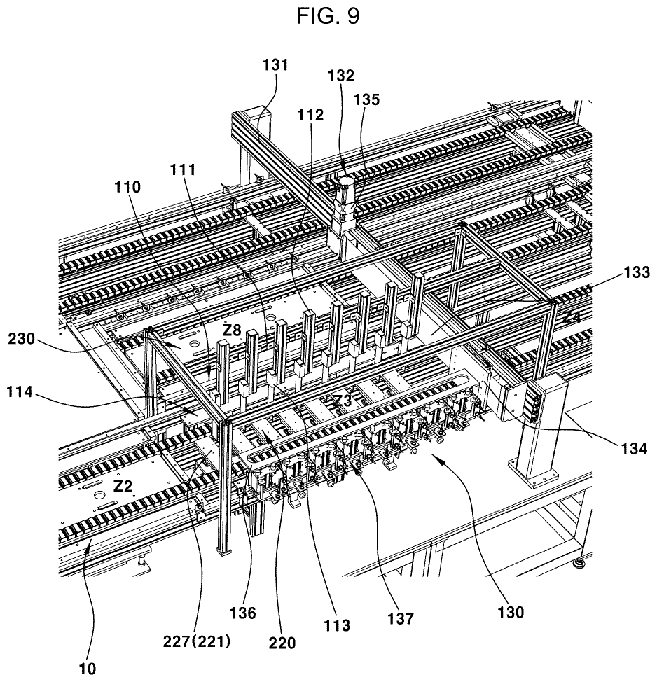

FIG. 13 is a perspective view illustrating the pusher unit 137, according to an exemplary embodiment of the present disclosure. As illustrated in the drawings, each of the pusher units 137 may comprise a lift actuator 138, a lift frame 141, and a pushing portion 144.

According to an exemplary embodiment of the present disclosure, each of the pusher units 137 may have a corresponding lift actuator 138 and may be configured to independently move up and down by the corresponding lift actuator 138. Here, the lift actuator 138 may comprise a cylinder mechanism having a piston rod (not shown) configured to move forward and backward in the up-down direction, and may be, specifically, an air cylinder or a hydraulic cylinder.

According to an exemplary embodiment, it the cell separator 130, the operations of the linear moving mechanism 132 and the lift actuator 138 may be controlled by the controller 120. Specifically, the operation of the linear actuator 135 of the linear moving mechanism 132 and the operation of the cylinder mechanism, which is the lift actuator 138, may be controlled by the controller 120.

In each of the pusher units 137, the cylinder mechanism, which is the lift actuator 138, and a side surface bracket 140 integrally coupled to the cylinder mechanism, may be integrally fixedly coupled to the mount support 136, and the lift frame 141 may be integrally fixed to a lower end portion of the piston rod (not shown).

Moreover, a pushing portion 144 configured to push pallets 3 loaded with issue cells 1b may be mounted to the lift frame 141. The pushing portion 144 may comprise a plate-shaped member positioned apart from a front surface of the lift frame 141.

The pushing portion 144 may be coupled to the lift frame 141 via a pair of guide shafts 142. The pair of guide shafts 142 may have a front end portion integrally fixed to a rear surface of the pushing portion 144 and may have a rear end portion coupled to the lift frame 141.

Here, the pair of guide shafts 142 may be coupled to the lift frame 141 in a manner that allows for axial sliding movement while penetrating the lift frame 141. Moreover, a spring 143 that elastically supports the pushing portion 144 on the lift frame 141 may be mounted on each guide shaft 142 between the lift frame 141 and the pushing portion 144.

When the pushing portion 144 of each of the pusher units 137 is lowered by the lift actuator 138, it may be ready for the pallets 3 loaded with battery cells 1 to be pushed transversely within the barcode reading zone Z3.

In other words, the pushing portion 144 of each of the pusher units 137 may be lowered to a height sufficient to push the pallets 3 transversely, while in the elevated state, the pushing portion 144 is positioned above the battery cells 1 and pallets 3 so as not to push the battery cells 1 and pallets 3 transversely.

Therefore, once an issue cell 1b is identified by the controller 120, only the pusher unit 137 at the issue cell position among the plurality of pusher units 137 may operate to push the issue cell 1b transversely. Here, the lift actuator 138 of the pusher unit 137 at the issue cell position may be operated by the controller 120, and the pushing portion 144 of the pusher unit 137 may be lowered by the lift actuator 138 only at the issue cell position.

Afterwards, when the linear moving mechanism 132 operates and the moving block 134 slides along the guide rail 133, all of the plurality of pusher units 137 may move in the transverse direction together with the moving block 134. Here, only the issue cell 1b and the pallet 3 loaded with the issue cell 1b may move in the transverse direction by the pusher unit 137 whose pushing portion 144 has lowered.

The controller 120 may be configured to not only lower the lift actuator 138 only in the pusher unit 137 at the issue cell position, but also lift only the individual pallet lift unit 221 at the issue cell position in the second pallet lift device 220 within the barcode reading zone Z3.

Moreover, when moving the issue cell 1b in the transverse direction from the barcode reading zone Z3 to the issue cell collection zone Z8, the controller 120 may be configured to elevate the third pallet lift device 230 within the issue cell collection zone Z8.

Accordingly, only the pallet 3 loaded with the issue cell 1b may be elevated by the individual pallet lift unit 221 of the second pallet lift device 220, and only the pusher unit 137 at the issue cell position may be lowered.

Accordingly, when the entire pusher unit 137 is moved by the linear moving mechanism 132, only the pallet 3 loaded with the issue cell 1b may be moved from the pallet lift unit 221 of the second pallet lift device 220 to the third pallet lift device 230 by the pusher unit whose pushing portion 144 has been lowered.

After all, only the pallet 3 loaded with the issue cell 1b may be selectively moved from the barcode reading zone Z3 of the transfer conveyor 10 to the issue cell collection zone Z8 of the issue cell conveyor 20.

Once the issue cell 1b is separated from the good cell 1a, the individual pallet lift unit 221 of the second pallet lift device 220 may be lowered back again by the controller 120, and the third pallet lift device 230 may also be lowered back again by the controller 120.

Afterwards, the issue cell 1b separated into the issue cell collection zone Z8 may be transferred to the issue cell discharge zone Z9 along the issue cell conveyor 20 by the chain 21 of the issue cell conveyor 20, and then moved and discharged to the cell storage bin 4 by the cell discharge device 310 at a predetermined cell discharge position.

After the issue cell 1b is moved and discharged outside at the issue cell discharge zone Z9, the remaining empty pallet 3 may then be transferred to the pallet discharge point P1 by the chain 21 of the issue cell conveyor 20, and then moved in the transverse direction to the pallet entry point P2 of the retrieval conveyor 30 by the third pallet mover 170.

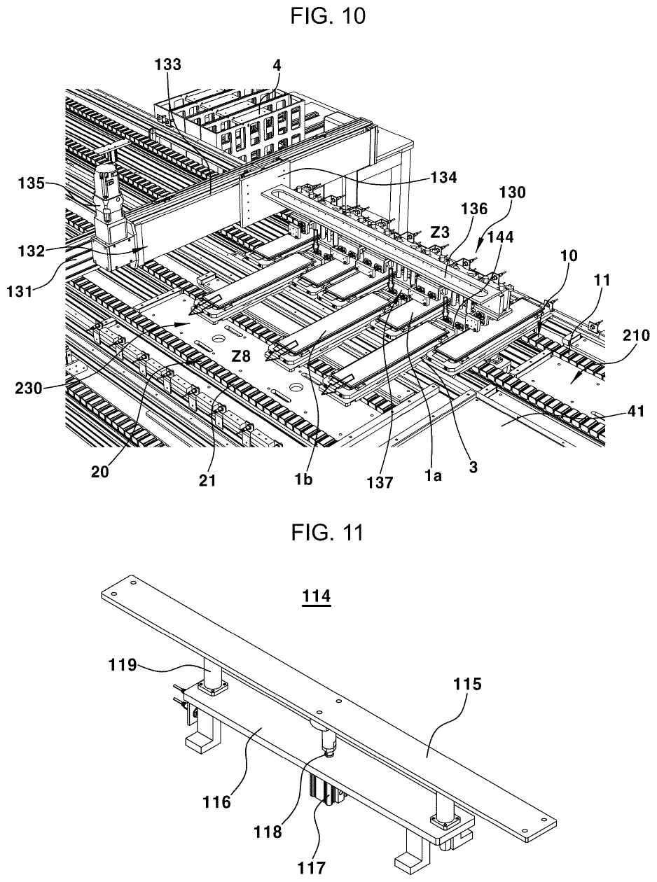

FIG. 14 is a view illustrating a state in which an empty pallet 3 at the pallet discharge point P1 is being moved to the pallet entry point P2 by the third pallet mover 170, according to an exemplary embodiment of the present disclosure.

As illustrated in the drawing, when an empty pallet 3 is moved in the transverse direction from the pallet discharge point P1 to the pallet entry point P2, the seventh pallet lift device 270 at the pallet discharge point P1 and the eighth pallet lift device 280 at the pallet entry point P2 may be controlled by the controller 120 to elevate the respective pallet lifts (which may be denoted by reference numeral “225”in FIG. 6).

Accordingly, the empty pallet 3 that has been elevated and spaced apart from the chain 21 may be moved from the pallet lift 225 of the seventh pallet lift device 270 to the pallet lift 225 of the eighth pallet lift device 280 by the third pallet mover 170.

Once moving of the empty pallet 3 is completed, the seventh pallet lift device 270 and the eighth pallet lift device 280 may be controlled by the controller 120 to lower the respective pallet lifts 225.

The empty pallet 3 may then be retrieved by the retrieval conveyor 30. The empty pallet 3 may be transferred to the empty pallet buffer zone Z7 by the chain 31 of the retrieval conveyor 30 and then finally retrieved into the cell input zone Z1 of the retrieval conveyor 30.

According to an exemplary embodiment of the present disclosure, the third pallet mover 170 may have a configuration similar to that of the second pallet mover 160. However, because only one empty pallet 3 needs to be moved from the pallet discharge point P1 of the issue cell conveyor 20 to the pallet entry point P2 of the retrieval conveyor 30, the third pallet mover 170 may be configured to have a single pusher unit.

The configuration of the third pallet mover 170 may be similar to those of the first pallet mover 150 and the second pallet mover 160, except that the third pallet mover 170 comprises a pusher unit capable of moving only one pallet 3. Because the third pallet mover 170 is no different from the first pallet mover 150 and the second pallet mover 160 in configuration, a detailed description of the third pallet mover 170 will be omitted.

Moreover, after the issue cell 1b and pallet 3 are moved to the issue cell conveyor 20, the good cells 1a and pallets 3 remaining in the barcode reading zone Z3 may be transferred into the cell buffer zone Z4 by the chain 11 of the transfer conveyor 10. The good cells 1a and pallets 3 may be aligned and wait in the cell buffer zone Z4 until being transferred to the cell discharge zone Z5.

After a group of good cells 1a are discharged outside from the cell discharge zone Z5 of the transfer conveyor 10 and the remaining empty pallets 3 are moved in the transverse direction to the cell discharge zone Z6 of the retrieval conveyor 30 by the second pallet mover 160, the fourth pallet lift device 240 mounted in the cell discharge zone Z5 of the transfer conveyor 10 may be lowered, and then the good cells 1a and pallets 3 in the cell buffer zone Z4 may be transferred to the cell discharge zone Z5 of the transfer conveyor 10 by the chain 11 of the transfer conveyor 10.

Meanwhile, once a predetermined number of issue cells 1b are collected in the issue cell discharge zone Z9 of the issue cell conveyor 20, or once all good cells 1a and pallets 3 waiting in the cell buffer zone Z4 are moved to the cell discharge zones Z5, Z6, the cell discharge device 310 may be configured to pick up the issue cells 1b transferred to the cell discharge point within the issue cell discharge zone Z9 and transfer to discharge the issue cells 1b to the cell storage bin 4.

Here, the issue cells 1b, together with the pallets 3, in the issue cell discharge zone Z9 may be transferred, one by one, toward the cell discharge point by the chain 21 of the issue cell conveyor 20. The issue cells 1b transferred to the cell discharge point may be sequentially transferred, one by one, to the cell storage bin 4 by the cell discharge device 310.

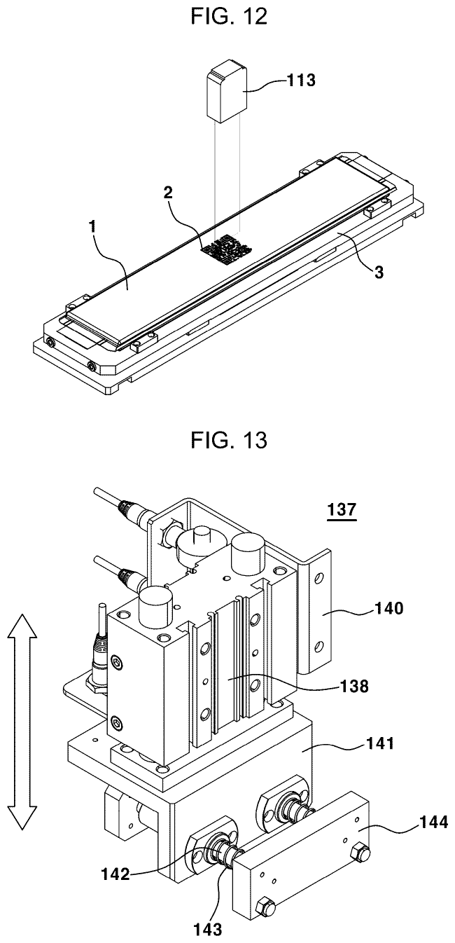

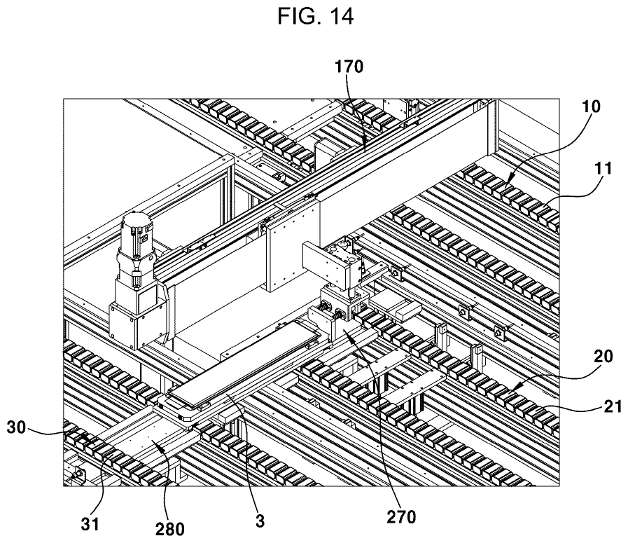

Hereinafter, the cell discharge process will be described in more detail with reference to the drawings. FIGS. 15 and 16 illustrate a state in which an issue cell 1b is being moved and discharged to the cell storage bin 4 by the cell discharge device 310, according to an exemplary embodiment of the present disclosure.

An issue cell 1b transferred to the cell discharge point within the issue cell discharge zone Z9 may be moved and discharged to cell storage bin 4 by the cell discharge device 310. After the issue cell 1b is discharged, the remaining empty pallet 3 may be transferred to the pallet discharge point P1 and then moved to the pallet entry point P2 of the retrieval conveyor 30, as described above. This process may be repeated each time a subsequent issue cell 1b and pallet 3 within the issue cell discharge zone Z9 are transferred to the cell discharge point.

According to an exemplary embodiment of the present disclosure, the cell discharge device 310 may be configured as a three-axis orthogonal unit. Specifically, the cell discharge device 310 may comprise two opposite longitudinal linear moving mechanisms 312, each configured to move a corresponding longitudinal movement block 313 along a corresponding guide rail 311 mounted by longitudinally extending in a forward-rearward direction on a corresponding support frame 43, wherein the support frames 43 comprise the left and right side portions of the battery cell separation system, a transverse support shaft 314 having opposite end portions each fixed to a corresponding longitudinal movement block 313 on the two opposite longitudinal linear moving mechanisms 312 and mounted to extend transversely across the transfer conveyor 10 and the retrieval conveyor 30, a transverse linear moving mechanism 315 configured to move a transverse moving block 316 along a guide rail 314a mounted transversely extending on the transverse support shaft 314, a lift mechanism 317 provided on the transverse moving block 316, and a pickup mechanism 318 provided to be movable up and down by the lift mechanism 317 and capable of selectively fix or release an issue cell 1b.

In the above configuration, the longitudinal linear moving mechanisms 312 at opposite sides are mechanisms to move the transverse support shaft 314, the transverse linear moving mechanism 315, the lift mechanism 317, and the pickup mechanism 318 all together in the longitudinal forward-rearward direction. The transverse linear moving mechanism 315 may be configured to move the lift mechanism 317 and the pickup mechanism 318 in the transverse direction, which is the length direction of the transverse support shaft 314.

The lift mechanism 317 may be configured to vary the height of the pickup mechanism 318 by moving the pickup mechanism 318 in the up-down direction, and the pickup mechanism 318 may be configured to absorb and pick up an issue cell 1b at the cell discharge point at the issue cell conveyor 20, and then to release the issue cell 1b into the cell storage bin 4.

According to an exemplary embodiment of the present disclosure, the longitudinal linear moving mechanism 312 and the transverse linear moving mechanism 315 may comprise a general LM system comprising an LM rail, an LM block, and a linear actuator. Moreover, the lift mechanism 317 may comprise a cylinder mechanism comprising a piston rod configured to move forward and backward in the up-down direction, and may comprise, specifically, an air cylinder or a hydraulic cylinder.

The pickup mechanism 318 may comprise a vacuum suction mechanism configured to apply suction to or release a battery cell 1 using a vacuum suction method. The pickup mechanism 318 may comprise a mechanism body 318a and a plurality of vacuum suction cups 318b mounted downwardly on the mechanism body 318a. The plurality of vacuum suction cups 318b may be connected to a vacuum supply device (not shown).

In this configuration, the pickup mechanism 318 may be elevated with the issue cell 1b at the cell discharge point being suction-fixed to the pickup mechanism 318 of the cell discharge device 310. The pickup mechanism 318 may be configured to be moved, together with the lift mechanism 317, in the transverse direction along the transverse support shaft 314 by the transverse linear moving mechanism 315, and at the same time, the transverse support shaft 314 may be configured to be moved in the longitudinal direction by the longitudinal linear moving mechanisms 312 at opposite sides. Accordingly, the issue cell 1b fixed to the pickup mechanism 318 may be configured to be moved to the cell storage bin 4 position, and then the issue cell 1b may be separated from the pickup mechanism 318 and moved into the cell storage bin 4.

During the issue cell discharge process, each time an issue cell 1b is moved to the cell storage bin 4 by the cell discharge device 310, all of the issue cells 1b waiting behind may be transferred, together with the pallets 3, one by one from the issue cell conveyor 20. Then, a subsequent issue cell 1b may be transferred to the cell discharge point and then moved to the cell storage bin 4 by the cell discharge device 310.

Next, all of the issue cells 1b waiting behind are transferred, together with the pallets 3, one by one, from the issue cell conveyor 20, and then another subsequent issue cell 1b may be transferred to the cell discharge point and then moved to the cell storage bin 4 by the cell discharge device 310.

This sequential transfer and discharge process for issue cells may be repeated, so that the issue cells 1b waiting in the issue cell discharge zone Z9 of the issue cell conveyor 20 are sequentially moved and discharged one by one from the cell discharge point to the cell storage bin 4.

Moreover, once two groups of good cells 1a are gathered within the cell buffer zone Z4 of the transfer conveyor 10, one group of good cells 1a from the two groups of good cells 1a waiting may be transferred to the cell discharge zone Z5 of the transfer conveyor 10 together with the pallet 3, and may then be moved in the transverse direction to the cell discharge zone Z6 of the retrieval conveyor 30 by the second pallet mover 160.

Moreover, the remaining group of good cells 1a and pallets 3 waiting in the cell buffer zone Z4 of the transfer conveyor 10 may be transferred to the cell discharge zone Z5 of the transfer conveyor 10 by the chain 11 of the transfer conveyor 10 by the operation of the transfer conveyor 10.

As an example, in a case where the number of battery cells in one group is eight, a total of sixteen good cells 1a may be collected in the cell buffer zone Z4 of the transfer conveyor 10, and, from the total of sixteen good cells 1a, eight good cells 1a may be first transferred to the cell discharge zone Z5 of the transfer conveyor 10 together with the pallets 3.

Then, from the cell discharge zone Z5 of the transfer conveyor 10, the eight good cells 1a and the pallets 3 may be moved in the transverse direction to the cell discharge zone Z6 of the retrieval conveyor 30 by the second pallet mover 160, and then the remaining eight good cells 1a waiting in the cell buffer zone Z4 of the transfer conveyor 10 may be transferred to the cell discharge zone Z5 of the transfer conveyor 10 together with the pallets 3.

Thereafter, as described above, the good cells 1a placed in the cell discharge zone Z5 of the transfer conveyor 10 and the cell discharge zone Z6 of the retrieval conveyor 30 may be simultaneously picked up from each of the pallets 3 by the cell take-out loader and removed from the cell separation process. Here, one group of good cells 1a on one conveyor and another group of good cells 1a on another conveyor may be simultaneously taken out.

After completing the removal of the good cells 1a, the empty pallets 3 remaining in the cell discharge zone Z6 of the retrieval conveyor 30 and the cell discharge zone Z5 of the transfer conveyor 10 may be sequentially retrieved one by one in groups to the cell input zones Z1, Z2 of the two conveyors 10, 30.

Here, one group of empty pallets (e.g., eight empty pallets) 3 placed in the cell discharge zone Z6 of the retrieval conveyor 30 may be transferred to the cell input zones Z1, Z2 by crossing over the empty pallet buffer zone Z7 of the retrieval conveyor 30 by the operation of the retrieval conveyor 30.

Another group of empty pallets (e.g., eight empty pallets) 3 placed in the cell discharge zone Z5 of the transfer conveyor 10 may be moved all at once in the transverse direction to the cell discharge zone Z6 of the retrieval conveyor 30 by the second pallet mover 160.

Next, another group of empty pallets 3 moved to the cell discharge zone Z6 of the retrieval conveyor 30 may also be transferred to the cell input zone Z1 by the retrieval conveyor 30. When the one group of empty pallets 3 transferred before the another group of empty pallets 3 arrives at the cell input zone Z1 of the retrieval conveyor 30, the one group of empty pallets 3 may be moved in the transverse direction from the cell input zone Z1 of the retrieval conveyor 30 to the cell input zone Z2 of the transfer conveyor 10 by the first pallet mover 150.

Thereafter, when the other group of empty pallets 3 arrives at the cell input zone Z1 of the retrieval conveyor 30, the other group of empty pallets 3 may wait within the cell input zone Z1 of the retrieval conveyor 30 until new battery cells 1 are input, like the empty pallets 3 within the cell input zone Z2 of the transfer conveyor 10.

According to an exemplary embodiment of the present disclosure, the retrieval of empty pallets 3 and the separation and external discharge of issue cells 1b may be performed simultaneously by the control of the controller 120. In other words, while the empty pallets 3 placed in the cell discharge zone Z6 of the retrieval conveyor 30 and empty pallets 3 placed in the cell discharge zone Z5 of the transfer conveyor 10 are retrieved to the cell input zones Z1, Z2 of the conveyors 10, 30, the issue cells 1b may be moved one by one from the cell discharge point at the issue cell conveyor 20 to the cell storage bin 4 by the cell discharge device 310.

Meanwhile, FIG. 17 is a view illustrating the chains 11, 21, 31 used in the transfer conveyor 10, the retrieval conveyor 30, and the issue cell conveyor 20, according to an exemplary embodiment of the present disclosure. Chain units 31a, as illustrated in the drawings, may be connected to make up the chains 11, 21, 31 of the conveyors 10, 20, 30. FIG. 17 illustrates a main stopper device 320 as well, according to an exemplary embodiment of the present disclosure.

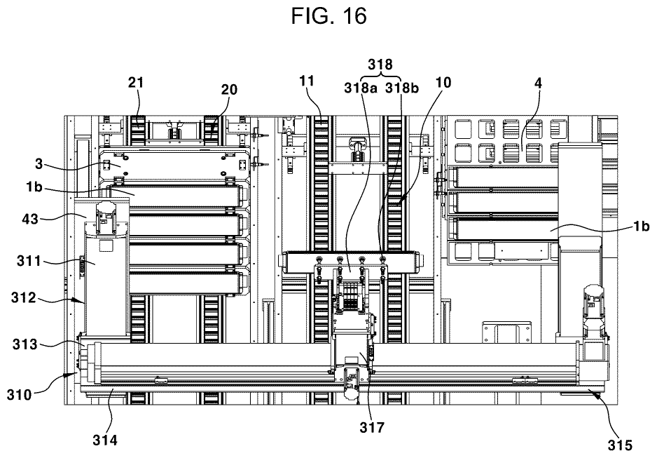

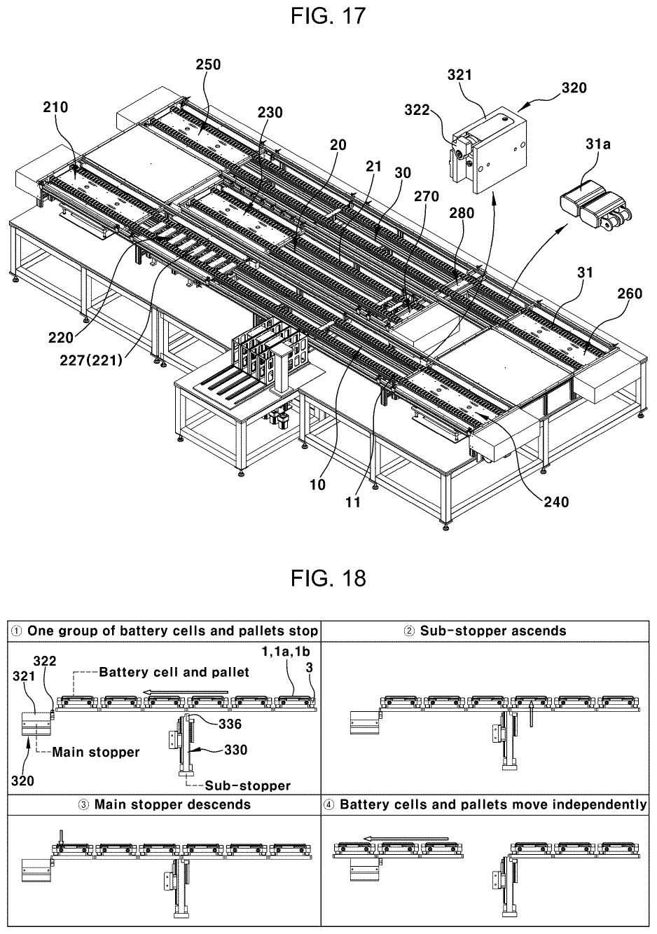

FIG. 18 is a view illustrating the operating states of the main stopper device 320 and a sub-stopper device 330, according to an exemplary embodiment of the present disclosure, and FIG. 19 is a perspective view illustrating the sub-stopper device 330, according to an exemplary embodiment of the present disclosure.

As an example, a main stopper 322 and a sub-stopper 336 may be mounted in the cell buffer zone Z4 of the transfer conveyor 10. The main stopper 322 and the sub-stopper 336 may be mounted below the chain 11 in the cell buffer zone Z4.

Specifically, the main stopper device 320 may be mounted between the cell buffer zone Z4 and the cell discharge zone Z5 of the transfer conveyor 10, and the sub-stopper device 330 may be mounted behind the main stopper device 320 with respect to the battery cell transfer path.

Here, the number of good cells transferred from the cell buffer zone Z4 to the cell discharge zone Z5 may be set or adjusted by the main stopper device 320 and the sub-stopper device 330.

The main stopper device 320 and the sub-stopper device 330 may be mounted in locations, in addition to the cell buffer zone Z4, where restrictions in movement and location of empty pallets 3 or pallets 3 loaded with battery cells 1 are needed on each conveyor 10, 20, 30.

The operations of the main stopper device 320 and the sub-stopper device 330 may be controlled by the controller 120. The main stopper device 320 may comprise a main body 321 fixedly mounted below a chain of a corresponding conveyor (e.g., the chain of the transfer conveyor), an actuator (not shown) mounted to the main body 321, and the main stopper 322 configured to move up and down in the main body 321 by driving of the actuator.

In the main stopper device 320, the upper end height of the main stopper 322 may vary depending on the up-down operation of the main stopper 322, so the main stopper 322 may directly come into contact with the pallet 3 on the chain that is driven and moving or may be released from the contact with the pallet 3.

When the main stopper 322 elevates, the main stopper 322 comes into contact with the pallet 3, preventing the movement of the pallet 3, and subsequent pallets after the pallet are not transferred by the chain. Conversely, when the main stopper 322 releases the contact and restriction, the corresponding pallet 3 and subsequent pallets may be transferred by the chain.

As such, depending on the up-down operation of the main stopper 322 in the main stopper device 320, the movement of the pallet 3 may be restricted so that the main stopper 322 does not move together with the chain, or conversely, the restriction on the movement of the pallet 3 is released so that the pallet 3 may move together with the chain,.

According to an exemplary embodiment of the present disclosure, the sub-stopper device 330 also may be configured such that the sub-stopper 336 is selectively moved up and down by an actuator 332. The sub-stopper device 330 may be, separate from the main stopper device 320, additionally mounted on a conveyor where the position of pallets needs to be regulated and controlled.

The sub-stopper device 330 is illustrated in FIG. 14 as well, and as illustrated in the drawings, the sub-stopper device 330 of the same configuration may be additionally mounted below the chain 21 within the issue cell discharge zone Z9.

The sub-stopper device 330 may comprise a fixed member 331 fixedly mounted on a fixed structure below a chain of a conveyor, an actuator 332 mounted to the fixed member 331, and the sub-stopper 336 may be configured to move up and down by the actuator 332.

The actuator 332 of the sub-stopper device 330 may comprise a cylinder mechanism comprising a piston rod 334 that is configured to move forward and backward in the up-down direction, wherein the piston rod 334 is arranged downwardly on a main body 333 of the cylinder mechanism, which is the actuator 332. Accordingly, the piston rod 334 may be provided to move downwardly forward and upwardly backward in the main body 333 of the cylinder mechanism, which is the actuator 332.

A total of two sub-stoppers 336 may be provided in the sub-stopper device 330, wherein the sub-stoppers 336 may be mounted on opposite end portions of a movable member 335, respectively. The movable member 335 may have a structure extending to the left and right, with a central portion of the movable member 335 fixed to the piston rod 334.

When the piston rod 334 of the sub-stopper device 330 moves backward and the movable member 335 is pulled upward, the sub-stoppers 336 on the opposite sides of the movable member 335 may be elevated together with the elevating movable member 335, and the upper end portions of the sub-stoppers 336 may protrude above the chain at the corresponding position, restricting the movement of the pallet 3.

The main stopper 322 of the main stopper device 320 and the sub-stopper 336 of the sub-stopper device 330 may be arranged at positions not interfering with the chain during the up-down operation.

Accordingly, depending on the up-down operation, the main stopper 322 and the sub-stopper 336 may be configured to either restrict the movement of only the pallet 3 positioned above the main stopper 322 and the sub-stopper 336, even when the chain is driven and moving, or release the restriction on the pallet 3 so that the pallet 3 may move together with the chain.

FIG. 18 illustrates a state in which the position of each pallet 3 loaded with a battery cell 1 is controlled and regulated by the main stopper 322 and the sub-stopper 336, according to an exemplary embodiment of the present disclosure. The pallets 3 loaded with battery cells 1 or the empty pallets 3 may be transferred in the same direction as the chain 11, 21, 31 while seated on the chain of the conveyor.

During the transfer of the pallets 3, when the main stopper 322 of the main stopper device 320 is elevated, one group of pallets (e.g., six or eight pallets) 3 may be stopped (see \textcircled{1} of FIG. 18).

Moreover, when the sub-stopper 336 is elevated (see \textcircled{2} of FIG. 18) and then the main stopper 322 is lowered (see \textcircled{3} of FIG. 18) with the sub-stopper device 330 positioned behind the pallets 3, which are desired to be moved independently, only some pallets (three pallets in FIG. 18) 3 from the one group of pallets may be independently transferred by the chain 11, 21, 31 (see \textcircled{4} of FIG. 18). Here, even when the chain 11, 21, 31 moves, the remaining pallets 3, whose movement is restricted by the elevated sub-stopper 336, may not move and remain stationary.

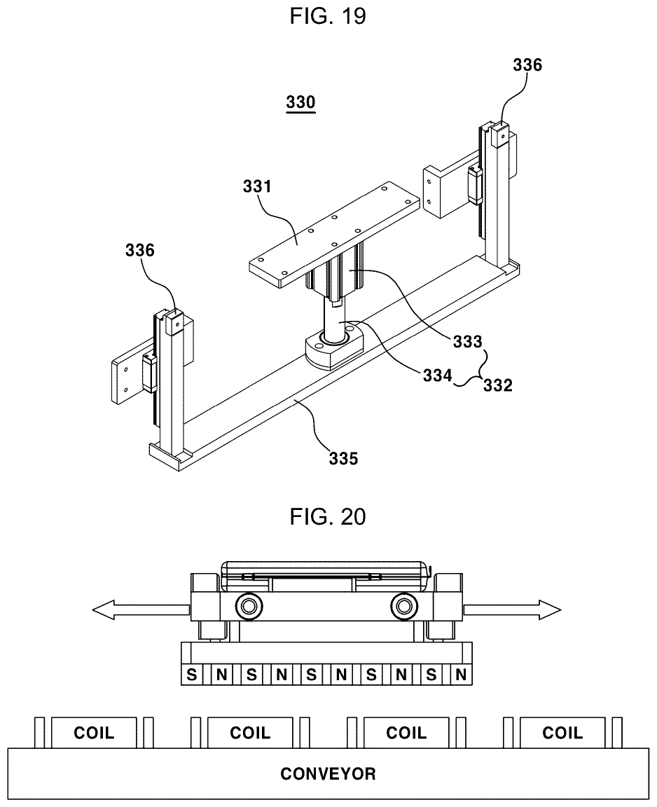

FIG. 20 is a cross-sectional view illustrating a linear magnetic moving system (LMS) conveyor, according to an exemplary embodiment of the present disclosure. The battery cell separation system, according to an exemplary embodiment of the present disclosure, may be configured to separate issue cells from good cells for the production of a battery module assembly (BMA). The LMS conveyor may also be configured to be used to transfer empty pallets or pallets loaded with battery cells.

An LMS is a system that is configured to move magnetically using a magnetic field between coils and magnets. The LMS conveyor may comprise a plurality of coils mounted on a conveyor, a plurality of magnets mounted on a moving plate, and a control device configured to control the current applied to each of the coils. Here, the control device may comprise the controller described above.

Unlike a rotary motor that generates and outputs a rotational force, the LMS is a system that is configured to generate and output a linear movement force. The coil-mounted conveyor may correspond to the stator of a general rotary motor, and the magnet-mounted moving plate may correspond to the rotor of a general rotary motor.

In the LMS conveyor, the magnet-mounted moving plate may be configured to be controlled to be moved to a predetermined position along the coil-mounted conveyor, using the electromagnetic interaction between the coil and the magnet.

When the LMS conveyor described above is used, devices to control the position of pallets on the conveyor, such as the pallet lift device and the pallet mover, may be deleted, except for the cell bring-in loader, the cell take-out loader, the barcode reader (BCR), and the cell discharge device configured as a three-axis orthogonal unit, simplifying the system.

The battery cell separation system, according to various embodiments of the present disclosure, has been described in detail. The battery cell separation system, according to various embodiments of the present disclosure, is capable of separating and discharging defective battery cells from good battery cells during the manufacturing and production process of a BMA.

Particularly, the battery cell separation system, according to the present disclosure, is configured to separate and discharge defective battery cells on a cell-by-cell basis during the production process of a BMA, minimizing a decrease in operating rate in a battery production line.

Furthermore, the battery cell separation system, according to the present disclosure, comprises a cell buffer zone Z4, minimizing battery production line downtime and resulting reduced operating rates even when defective cells occur consecutively, and also varying the unit of cells to be brought in and taken out when the unit of input cells or the number of cells per battery module changes.

As is apparent from the above description, the present disclosure provides the following effects.

The battery cell separation system, according to the present disclosure, may be configured to separate and discharge defective battery cells on a cell-by-cell basis during the production process of a BMA, minimizing a decrease in operating rate in a battery production line.

Furthermore, the battery cell separation system, according to the present disclosure, provides a cell buffer zone, minimizing battery production line downtime and resulting reduced operating rates even when defective cells occur consecutively, and also varying the unit of cells to be brought in and taken out when the unit of input cells or the number of cells per battery module changes.

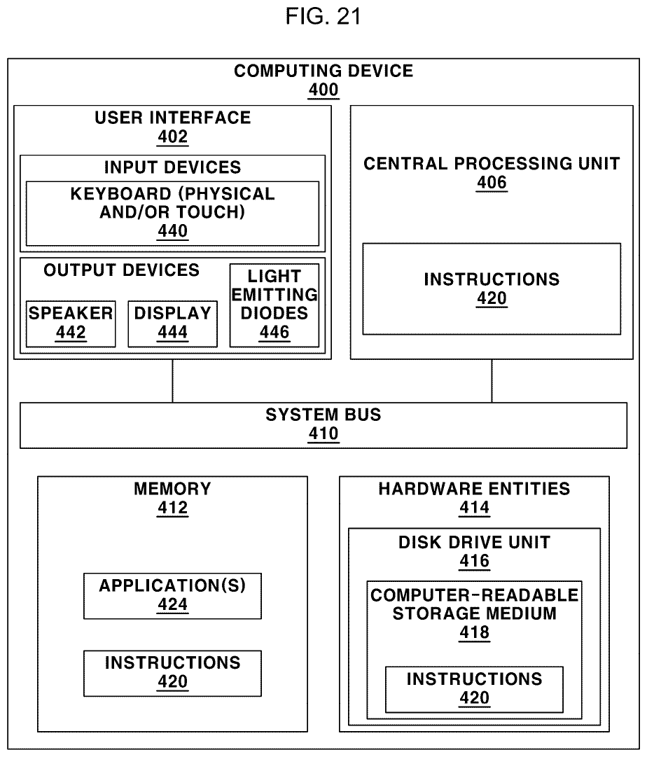

Referring now to FIG. 21, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions. The controller 120 may be an example of computing device 400 and/or may comprise one or more components of computing device 400.

The hardware architecture of FIG. 21 represents one example implementation of a representative computing device configured to implement at least a portion of the systems/devices and method(s)/control logic(s) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 21, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure. According to various embodiments, one or more computer applications 424 may be stored on the memory 412.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A battery cell separation system, comprising:
a transfer conveyor configured to transfer one or more pallets loaded with battery cells to a cell discharge zone;
an issue cell identification device configured to identify an issue cell from the battery cells transferred by the transfer conveyor,
wherein the issue cell is a battery cell with one or more quality defects; and
an issue cell conveyor configured to transfer the issue cell and a pallet loaded with the issue cell to an issue cell discharge zone.

2. The battery cell separation system of claim 1, further comprising:
a cell separator configured to move and separate the issue cell identified by the issue cell identification device, together with the pallet, from the transfer conveyor to the issue cell conveyor; and
a cell discharge device configured to pick up the issue cell transferred to the issue cell discharge zone to transfer and discharge out the issue cell.

3. The battery cell separation system of claim 2, wherein:
the transfer conveyor:
has a cell buffer zone provided at a location immediately before the cell discharge zone with respect to a transfer path of the battery cells; and
comprises a chain conveyor configured to transfer pallets using a chain that is configured to be driven and moving, and
good cells, loaded onto pallets, remaining after the issue cell is separated are set to wait in the cell buffer zone until entering the cell discharge zone.

4. The battery cell separation system of claim 3, further comprising:
a main stopper device configured to restrict a movement of the pallets based on a main stopper being elevated from below to above the chain by driving of an actuator; and
a sub-stopper device mounted behind the main stopper device with respect to a transfer path of the battery cells in the transfer conveyor and configured to restrict the movement of the pallets based on a sub-stopper being elevated from below to above the chain by driving of an actuator,
wherein:
the main stopper device is mounted between the cell buffer zone and the cell discharge zone of the transfer conveyor, and
by the main stopper device and the sub-stopper device, one or more good cells to be transferred from the cell buffer zone to the cell discharge zone are set or adjusted.

5. The battery cell separation system of claim 2, wherein the issue cell identification device comprises a barcode reader unit comprising a barcode reader configured to read a barcode attached or marked on each battery cell to identify an issue cell from the battery cells.

6. The battery cell separation system of claim 2, wherein the cell discharge device comprises:
a pickup mechanism configured to pick up an issue cell loaded on a pallet at a cell discharge point within the issue cell discharge zone set on the issue cell conveyor; and
a three-axis orthogonal unit configured to move the pickup mechanism in one or more orthogonal directions to discharge the issue cell.

7. The battery cell separation system of claim 2, wherein:
the transfer conveyor has an issue cell identification zone in a transfer path of the battery cells,
the issue cell identification device is configured to identify, in the issue cell identification zone, an issue cell from a predetermined number of battery cells, and
the cell separator is configured to selectively move only the identified issue cell, together with a pallet loaded with the issue cell, from the predetermined number of battery cells transferred into the issue cell identification zone to the issue cell conveyor.

8. The battery cell separation system of claim 7, wherein:
the cell separator comprises:
a plurality of pusher units configured to:
individually elevate or lower the predetermined number of battery cells transferred into the issue cell identification zone; and
push the identified issue cell while being lowered to thereby move the issue cell to the issue cell conveyor; and
a linear moving mechanism configured to transfer the plurality of pusher units in a transverse direction across the transfer conveyor and the issue cell conveyor,
the battery cell separation system further comprises a controller configured to control an operation of the cell separator,
the pusher units each comprise:
a lift actuator configured to be controlled by the controller; and
a pushing portion configured to move up and down by the lift actuator, and
the controller is configured to control an operation of the lift actuator so that the pushing portion is lowered relative to a pusher unit positioned at the identified issue cell.

9. The battery cell separation system of claim 7, wherein:
the issue cell conveyor has an issue cell collection zone,
the issue cell, moved by the cell separator, is set to be placed in the issue cell collection zone,
the battery cell separation system further comprises:
one or more pallet lift devices, mounted in the issue cell identification zone of the transfer conveyor and an issue cell collection zone of the issue cell conveyor, respectively, and configured to selectively elevate or lower a pallet located in a corresponding zone; and
a controller configured to control an operation of each of the pallet lift devices, and
the controller is configured to control the operation of each of the pallet lift devices so that the pallet loaded with the issue cell is moved from the issue cell identification zone of the transfer conveyor to the issue cell collection zone of the issue cell conveyor by the cell separator with the pallet being in an elevated state.

10. The battery cell separation system of claim 9, wherein:
the transfer conveyor and the issue cell conveyor each comprise a chain conveyor configured to transfer pallets using a chain that is configured to be driven and moving, and
the pallet lift devices are each configured to, while pallets are being moved from the issue cell identification zone to the issue cell collection zone, elevate the pallets so as to separate the pallets from the chain.

11. The battery cell separation system of claim 9, wherein the pallet lift device mounted in the issue cell identification zone of the transfer conveyor comprises a plurality of pallet lift units configured to individually elevate or lower pallets located within the issue cell identification zone of the transfer conveyor.

12. The battery cell separation system of claim 2, wherein:
the transfer conveyor is configured to transfer good cells remaining after an issue cell is separated by the cell separator to the cell discharge zone for external discharge,
the battery cell separation system further comprises:
a retrieval conveyor configured to retrieve empty pallets remaining after good cells are discharged from the cell discharge zone of the transfer conveyor to a cell input zone where battery cells are input;
two parallel zones at an infeed side, each defined toward a same end of the transfer conveyor and the retrieval conveyor, and each designated as cell input zones into which a predetermined number of battery cells are input so as to be sorted into issue cells and good cells; and
an infeed-side pallet mover configured to move empty pallets or pallets loaded with battery cells from the cell input zone of the retrieval conveyor to the cell input zone of the transfer conveyor, and
the predetermined number of battery cells to be sorted are configured to be put onto empty pallets retrieved to the cell input zone of the retrieval conveyor and onto empty pallets moved from the cell input zone of the retrieval conveyor to the cell input zone of the transfer conveyor by the infeed-side pallet mover.

13. The battery cell separation system of claim 12, further comprising a controller configured to control an operation of the infeed-side pallet mover,
wherein, based on the predetermined number of battery cells being put into the cell input zone of the retrieval conveyor and into the cell input zone of the transfer conveyor and the battery cells in the cell input zone of the transfer conveyor being transferred together with the pallets to the issue cell identification zone where issue cells are identified by the issue cell identification device, the controller is configured to control the infeed-side pallet mover to move the battery cells and the pallets put into the cell input zone of the retrieval conveyor to the cell input zone of the transfer conveyor.

14. The battery cell separation system of claim 12, further comprising:
one or more pallet lift devices mounted in the cell input zone of the transfer conveyor and the cell input zone of the retrieval conveyor, respectively, and configured to selectively elevate or lower a pallet located in a corresponding zone; and
a controller configured to control an operation of each of the one or more pallet lift devices,
wherein:
the transfer conveyor and the retrieval conveyor each comprise a chain conveyor configured to transfer pallets using a chain that is driven and moving, and
the controller is configured to control each of the pallet lift devices to elevate and separate the pallets from the chain while the pallets are being moved from the cell input zone of the retrieval conveyor to the cell input zone of the transfer conveyor by the infeed-side pallet mover.

15. The battery cell separation system of claim 2, wherein:
the transfer conveyor is configured to transfer good cells remaining after an issue cell is separated by the cell separator to the cell discharge zone for external discharge, and
the battery cell separation system further comprises:
a retrieval conveyor configured to retrieve empty pallets remaining after good cells are discharged from the cell discharge zone of the transfer conveyor to a cell input zone where battery cells are input;
two parallel zones at an outfeed side, each defined toward a same end of the transfer conveyor and the retrieval conveyor, and each designated as cell discharge zones where the good cells remaining after an issue cell is separated are discharged outside; and
an outfeed-side pallet mover configured to move empty pallets or pallets loaded with good cells from the cell discharge zone of the transfer conveyor to the cell discharge zone of the retrieval conveyor.

16. The battery cell separation system of claim 15, further comprising:
a controller configured to control an operation of the outfeed-side pallet mover,
wherein, based on the good cells being discharged outside from the cell discharge zone of the transfer conveyor and from the cell discharge zone of the retrieval conveyor and the empty pallets in the cell discharge zone of the retrieval conveyor being transferred for retrieval, the controller is configured to control the outfeed-side pallet mover to move the empty pallets in the cell discharge zone of the transfer conveyor to the cell discharge zone of the retrieval conveyor so as to retrieve the empty pallets; and
one or more pallet lift devices, mounted in the cell discharge zone of the transfer conveyor and the cell discharge zone of the retrieval conveyor, respectively, and configured to selectively elevate or lower a pallet located in a corresponding zone,
wherein:
the transfer conveyor and the retrieval conveyor each comprise a chain conveyor configured to transfer pallets using a chain that is driven and moving, and
the controller is configured to control each of the one or more pallet lift devices to elevate and separate the pallets from the chain while the pallets are being moved from the cell input zone of the retrieval conveyor to the cell input zone of the transfer conveyor by the outfeed-side pallet mover.

17. The battery cell separation system of claim 2, wherein:
the transfer conveyor is configured to transfer good cells remaining after an issue cell is separated by the cell separator to the cell discharge zone for external discharge,
the battery cell separation system further comprises a retrieval conveyor configured to retrieve empty pallets remaining after good cells are discharged from the cell discharge zone of the transfer conveyor to a cell input zone where battery cells are input,
the retrieval conveyor has an empty pallet buffer zone provided at a location immediately before the cell input zone with respect to a transfer path of the empty pallets being retrieved, and
the empty pallets are set to wait in the empty pallet buffer zone until entering the cell input zone.

18. The battery cell separation system of claim 2,
the transfer conveyor is configured to transfer good cells remaining after an issue cell is separated by the cell separator to the cell discharge zone for external discharge,
the battery cell separation system further comprises:
a retrieval conveyor configured to retrieve empty pallets remaining after good cells are discharged from the cell discharge zone of the transfer conveyor to a cell input zone where battery cells are input;
an empty pallet mover configured to move empty pallets remaining after issue cells are discharged by the cell discharge device from the issue cell conveyor to the retrieval conveyor;
a pallet lift device, mounted at a pallet discharge point on the issue cell conveyor where empty pallets are discharged and at a pallet entry point on the retrieval conveyor where empty pallets enter from issue cell conveyor, and configured to selectively elevate pallets; and
a controller configured to control operations of the empty pallet mover and the pallet lift device,
the issue cell conveyor and the retrieval conveyor each comprise a chain conveyor configured to transfer pallets using a chain that is driven and moving, and
the controller is configured to control the operation of the pallet lift device to elevate and separate the empty pallets from the chain while the empty pallets are being moved from the issue cell conveyor to the retrieval conveyor.

19. A battery cell separation system, comprising:
a computing device comprising a processor and a memory, wherein the memory is configured to store instructions that, when executed by the processor, are configured to cause the processor to:
cause a transfer conveyor to transfer one or more pallets loaded with battery cells to a cell discharge zone;
identify an issue cell from the battery cells transferred by the transfer conveyor,
wherein the issue cell is a battery cell with one or more quality defects; and
cause an issue cell conveyor to transfer the issue cell and a pallet loaded with the issue cell to an issue cell discharge zone.

20. The battery cell separation system of claim 19, wherein the computing device is further configured to:
cause a cell separator to move and separate the issue cell identified by the issue cell identification device, together with the pallet, from the transfer conveyor to the issue cell conveyor; and
cause a cell discharge device to pick up the issue cell transferred to the issue cell discharge zone to transfer and discharge out the issue cell.
